(19) United States
(12) Patent Application Publication
(10) Pub. No.: US 2011/0184831 A1
(43) Pub. Date: Jul. 28, 2011

(54) AN ITEM RECOMMENDATION SYSTEM

(76) Inventor: Andrew Robert Dalgleish, Victoria (AU)

(21) Appl. No.: 12/995,969

(22) PCT Filed: Jun. 2, 2009
(86) PCT No.: PCT/AU09/00691

§ 371 Date: Mar. 31, 2011

(30) Foreign Application Priority Data
Jun. 2, 2008 (AU) 2008902761

(51) Int. Cl. G06Q 30/00

(52) U.S. Cl. 705/26.7

(57) ABSTRACT

An item recommendation process, executed by a computer system, including:
receiving item data representing item features of at least one item;
receiving personal data representing personal features, and associated with a personal style profile, of at least one person from a user;
accessing and processing rules data representing links between item features and personal features of style profiles;
receiving inventory data representing available items in a retailer inventory of a retailer to the person; and
generating recommendation data representing an item recommendation of the item, selected based on the available items, the item features, the style profile and at least one link between them.

### FIELD

The present invention relates to an item recommendation system for recommending one or more items, e.g., clothing and accessories, for a person.

### BACKGROUND

Existing systems for use in fashion shopping allow a customer to browse products, i.e., items of interest, e.g., apparel, by various categories, including: type of item (e.g., fitted dress shirt, monk strap shoes, or women's dress jackets), brand (e.g., Jeffrey Bean, Cole-Haan or Mossimo), size, price, discount, seller, and customer ratings/reviews. The systems are, however, limited in their technical ability. The systems include components for display and selection of items, but are unable to process additional parameters, or include components, which provide more than a mere browsing facility. Current systems are only of benefit to a customer who knows what items of apparel they want.

It is desired to address or ameliorate one or more disadvantages or limitations associated with the existing systems, or to at least provide a useful alternative.

### SUMMARY

In accordance with the present invention, there is provided an item recommendation process, executed by a computer system, including:
receiving item data representing item features of at least one item;
receiving personal data representing personal features, and associated with a personal style profile, of at least one person from a user;
accessing and processing rules data representing links between item features and personal features of style profiles;
receiving inventory data representing available items in a retailer inventory of a retailer to the person; and
generating recommendation data representing an item recommendation of the item, selected based on the available items, the item features, the style profile and at least one link between them.

The present invention also provides an item recommendation process, executed by a computer system, including:
receiving item data representing item features of at least one item;
receiving personal data representing personal features, and associated with a personal style profile, of at least one person from a user, wherein the personal features relate to lifestyle activities;
accessing and processing rules data representing links between item features and personal features of style profiles; and
generating recommendation data representing an item recommendation of the item, selected based on the item features, the style profile and at least one link between them, wherein the link is between the lifestyle activities and the item features.

The present invention also provides an item recommendation process, executed by a computer system, including:
receiving item data representing item features of at least one item;
receiving personal data representing personal features, and associated with a personal style profile, of at least one person from a user;
accessing and processing rules data representing links between item features and personal features of style profiles;
generating recommendation data representing an item recommendation of the item, selected based on the item features, the style profile and at least one link between them; and
generating further recommendation data representing a further item recommendation of a further one item, selected based on the item features, the personal features, the link between them and the recommended item.

The present invention also provides an item recommendation system including a recommendation engine configured to:
receive item data representing item features of at least one item from a categorised items database;
receive personal data representing personal features in a personal style profile of at least one person from a user;
access rules data representing at least one link between the item features and the personal features, corresponding to the item in an expert rules database;
receive inventory data representing available items in a retailer inventory of a retailer to the person; and
generate recommendation data representing an item recommendation of the item, selected based on the available items, the item features, the personal features and the link between them.

The present invention also provides an item recommendation system including a recommendation engine configured to:
receive item data representing item features of at least one item from a categorised items database;
receive personal data representing personal features in a personal style profile of at least one person from a user, wherein the personal features relate to lifestyle activities;
access rules data representing at least one link between the item features and the personal features, corresponding to the item in an expert rules database; and
generate recommendation data representing an item recommendation of the item, selected based on the item features, the personal features and the link between them, wherein the link is between the lifestyle activities and the item features.

The present invention also provides an item recommendation system including a recommendation engine configured to:
receive item data representing item features of at least one item from a categorised items database;
receive personal data representing personal features in a personal style profile of at least one person from a user;
access rules data representing at least one link between the item features and the personal features, corresponding to the item in an expert rules database;
generate recommendation data representing an item recommendation of the item, selected based on the item features, the personal features and the link between them; and
generate further recommendation data representing a further item recommendation of a further one item, selected based on the item features, the personal features, the link between them and the recommended item.

### BRIEF DESCRIPTION OF THE DRAWINGS

Preferred embodiments are hereinafter further described, by way of example only, with reference to the accompanying drawings, which are not to scale, wherein:

FIG. 1A is a block diagram of an item recommendation system;

FIG. 1B is a block diagram of communication paths of the item recommendation system;

FIG. 2 is a block diagram of a software architecture in the item recommendation system;

FIG. 3 is a flow chart of an item recommendation process;

FIG. 4 is a block diagram of an instore item recommendation system;

FIG. 5 is a block diagram of a web-based item recommendation system;

FIG. 6 is a block diagram of a style directory database's connections;

FIG. 7 is a diagram of item style classification categories;

FIG. 8 is a diagram of item style category options;

FIG. 9 is a diagram of item style category option matching;

FIG. 10 is a diagram of an example of clothing item style classification;

FIG. 11 is a diagram of an item style classification numbering system;

FIG. 12 is a diagram of style profile classification categories;

FIG. 13 is a diagram of style profile category options;

FIG. 14 is a diagram of matching style profile classification categories and item style classification categories;

FIG. 15 is a diagram of an example of complete style profile category option set and complete item style category option set;

FIG. 16 is a diagram of multiple matching style profile category options;

FIG. 17 is a diagram of lifestyle classification categories;

FIG. 18 is a diagram of lifestyle category options;

FIG. 19 is a diagram of lifestyle category options and item style classification numbers using sub-categories;

FIG. 20 is a diagram of matching lifestyle category options and item style classification numbers using second sub-categories;

FIG. 21 is a block diagram of a personal style profile analysis program's connections;

FIG. 22 is a diagram of an example personal style profile analysis template—level 1;

FIG. 23 is a diagram of an example personal style profile analysis template—level 2;

FIG. 24 is a diagram of an example personal style profile analysis template—level 3;

FIG. 25 is a block diagram of a retailer's customer database's connections;

FIG. 26 is a diagram of an example purchase order profile form;

FIG. 27 is a diagram of an example item order profile form;

FIG. 28 is a diagram of an example item style classification profile form;

FIG. 29 is a block diagram of an inventory order classification program's connections;

FIG. 30 is a block diagram of an administration program's connections;

FIG. 31 is a block diagram of a purchase order database's connections;

FIG. 32 is a diagram of an example stock inventory database basic template;

FIG. 33 is a block diagram of a stock inventory database's connections;

FIG. 34 is a block diagram of a daily consumer access and purchasing program's connections;

FIG. 35 is a flow chart of a process performed by an instore daily consumer access and purchasing program;

FIG. 36 is a flow chart of a process performed by a web-based daily consumer access and purchasing program;

FIG. 37 is a block diagram of a lifestyle information directory's connections;

FIG. 38 is a block diagram of a CLASS information site's connections;

FIG. 39 is a block diagram of a P.O.S. program's connections;

FIG. 40 is a block diagram of a USB key's connections;

FIG. 41 is a block diagram of a consumer's computer's connections;

FIG. 42 is a block diagram of a member's style profile card's connections;

FIG. 43 is a block diagram of a create or update your own personal style profile module's connections;

FIG. 44 is a block diagram of an instore computer terminal's connections;

FIG. 45 is a block diagram of a retailer's website's connections;

FIG. 46 is a block diagram of a class head office service centre's connections; and

FIG. 47 is a block diagram of an independent styling studio's connections.

### DETAILED DESCRIPTION OF THE PREFERRED EMBODIMENTS

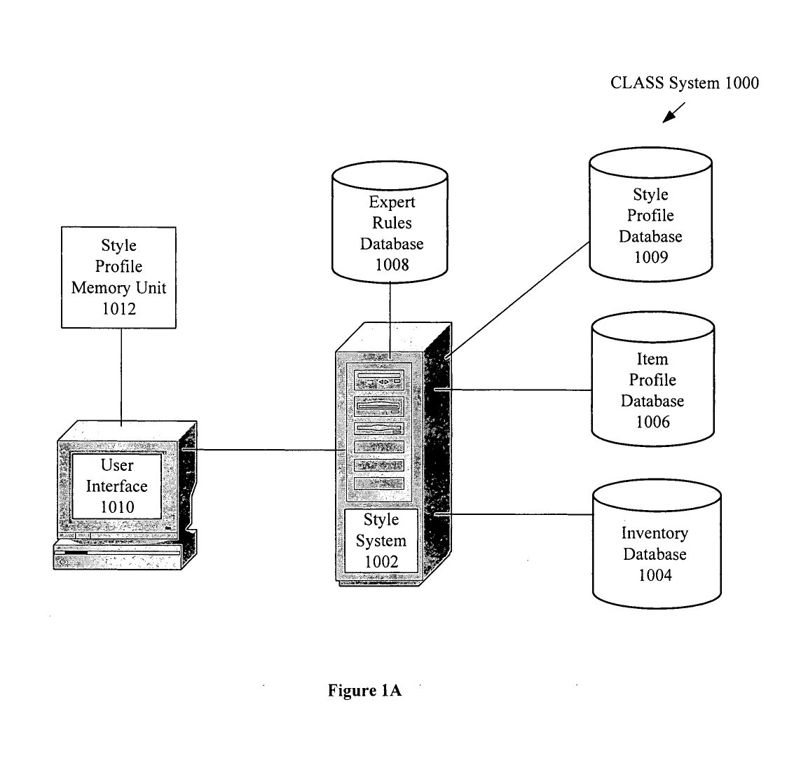

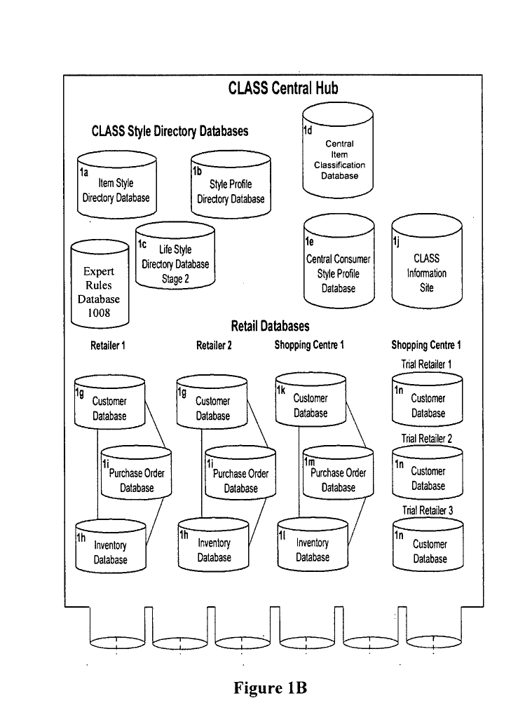

As shown in FIG. 1A, an item recommendation computer system, in the form of a clothing life and style selection (CLASS) system 1000, includes: a style system 1002 implemented on a computing platform in communication with an inventory database 1004, an item profile database 1006, an expert rules database 1008 and a user interface 1010. In some embodiments, the CLASS system 1000 includes a style profile database 1009 for storing consumers' personal style profiles. Alternatively or additionally, the user interface 1010 can be in communication with a style profile memory unit 1012 for storing at least one personal style profile of a consumer.

The style system 1002 includes computer program code stored on a computer-readable storage medium. In the described embodiment, the style system 1002 is a standard computer system such as an 32-bit or 64-bit Intel Architecture based computer system, and at least some of the processes executed by the CLASS system 1000, including those executed by a recommendation engine, described hereinafter, are implemented with programming instructions of one or more software modules stored on non-volatile (e.g., hard disk) storage associated with the computer system. In alternative embodiments, at least parts of the software modules are implemented as one or more dedicated hardware components, such as application-specific integrated circuits (ASICs) and/or field programmable gate arrays (FPGAs). The computer system includes standard computer components, including random access memory (RAM), at least one computer processor, and external interfaces all interconnected by a bus. The external interfaces include universal serial bus (USB) interfaces, a network interface connector (NIC) which connects the computer system to a communications network such as the Internet, and a display adapter, which is connected to a display device such as an LCD panel display. The computer system also includes a number of standard software modules, including an operating system (such as Linux or Microsoft Windows XP), web server software (such as Apache, available at http://www.apache.org), scripting language support (such as PHP, available at http://www.php.net, or Microsoft ASP), and structured query language (SQL) support (such as MySQL, available from http://www.mysql.com, which allows data to be stored in and retrieved from an SQL database, and the inventory database 1004, item profile database 1006 and the expert rules database 1008). The inventory database 1004, item profile database 1006 and the expert rules database 1008 are stored in computer-readable media, and are each accessible using a database management system (DBMS). The databases 1004, 1006, 1008 can be stored in the computer system, or in separate computer servers in communication with the computer system. The user interface 1010 may be served to a user over the Internet, e.g., as a website for the user's web browser, or available in a computing device in a retailer store (e.g., as part of a kiosk or booth). Together, the web server, scripting language, and SQL modules provide the computer system with the general ability to allow users of the Internet with standard computing devices equipped with standard web browser software to access the system: e.g., for online embodiments of the recommendation engine. It will be understood by those skilled in the art that the specific functionality provided by the system to such users is provided by scripts accessible by the web server, including the one or more software modules, and also any other scripts and supporting data, including markup language (e.g., HTML, XML) scripts, PHP (or ASP), and/or CGI scripts, image files, style sheets, and the like.

As shown in FIG. 1B, in the some embodiments, the CLASS system 1000 is configured as a centralised computer system or a “CLASS Central Hub” that includes the style system 1002, the inventory database 1004, the item profile database 1006, the expert rules database 1008 and the style profile database 1009. The databases in the CLASS Central Hub are stored on load-balanced database servers including DBMS programs that share the data across a plurality of servers as required by load. The inventory database 1004 includes a plurality of inventory databases 1h,1l for a plurality of retailers who use the CLASS Central Hub, each of which includes an inventory of items associated with each retailer. The item profile database 1006 includes a Central Item Classification Database 1d with item data for all items classified in the CLASS system 1000; this item data is sent to a retailer's inventory database 1h,1l on request from the retailer (e.g., when relevant items are ordered by the retailer). The style profile database 1009 includes a Central Consumer Style Profile Database 1e with personal data for all persons classified in the CLASS system 1000: this personal data is sent to a retailer's customer database 1g,1k on request from the retailer and/or on request from the consumer associated with the personal profile data. The consumer or “owner” of the personal style profile may allow that only selected retailers are able to access their personal data, while others cannot (e.g., selected based on an agreement to accept marketing communications material); similarly, a retailer may allow only selected consumers to use their personal data in relation to their inventory, e.g., based on a membership or purchase history.

The CLASS Central Hub also includes a CLASS Information Site database 1j include site data about the CLASS system 1000 for display to consumers, retailers, etc. The CLASS Central Hub includes a Rules database 1008, with the expert rules, together with: an Item Style Directory Database 1a for storing a list of all features that may be associated with an item in the item data (these features are referred to as “item values” of “item parameters” hereinafter); a Style Profile Directory Database 1b for storing a list of all personal characteristics and preferences that may be associated with a person in the personal data (these characteristics and preferences are referred to as “personal values” of “personal parameters” hereinafter); and a Life Stye Directory Database 1c for storing a list of all personal life style preferences that may be associated with a person in the personal data (these preferences are also referred to as “personal values” of “personal parameters” hereinafter). The customer databases 1g,1k and the inventory databases 1h,1l can be managed using separate database systems and servers; alternatively or additionally, the customer databases 1g,1k and the inventory databases 1h,1l can be virtual databases, included as marked records in the CLASS Central Hub's Central Consumer Style Profile Database 1e and the Central Item Classification Database 1d respectively. The CLASS Central Hub is in communication with computer systems of the following parties via the Internet: an administrator of the CLASS system 1000 (referred to as the “CLASS Headquarters” or the “CLASS Head Office”), for maintaining and controlling operations of the CLASS system 1000; manufacturers and wholesalers of the items in the items data who can generate and send the item data for the Central Item Classification Database 1d; one or more retailers, including multi-brand retailers, vertical retailers, trial retailers, online retailers, retail stores, department stores and/or shopping centres representing a plurality of retail stores; consumers who use the CLASS system 1000 for browsing or purchasing the items; and image consultants and stylists who assist in the generation of the personal data and generate the expert rules data. The one or more trial retailers are associated with a shopping centre with customer databases. In for storing personal data for a temporary or limited period of time, e.g., during a testing or probationary stage.

The CLASS system 1000 may be accessed by users, including customers/consumers, administrators, retailers, wholesalers, manufacturers, traders, importers/exporters, expert stylists and administrators through the Internet. Internet access to the CLASS system 1000 is managed using a content management system, such as “Power Front” (http://www.powerfront.com), to provide reliable, rapid and secure online access. The Internet connectivity allows for a centralised online system where item information, personal information and recommendation information are stored and accessed by a central hub, allowing for convenient access by parties, in particular users and retailers. A centralised design also reduces the need for reuse of data between parties, e.g., a number of parties can access the expert rules in the expert rules database 1008 and may share portions of the inventory database 1004. Sharing the expert rules allows a first party to benefit from the expert styling rules, and in particular item classification described hereinafter, performed by a second party; e.g., a retailer may use expert rules—corresponding to an item—prepared by a manufacturer of the item. The central hub design also allows a plurality of users to share personal style profile information, e.g., to allow a user's friends and family members access to their personal style profile to allow other persons to generate recommendation information, e.g., for buying gifts for another person.

The CLASS system 1000 provides a personalized retail on-line and in-store purchasing service, designed to locate and recommend an item from a retailer's inventory that is matched as close as possible to a consumer's physical characteristics and requirements. The CLASS system 1000: (1) provides the consumer with a personal style profile that includes their styling and physical characteristics and recommends the type of clothing that will make them look their physical “best”; (2) provides the styling industry with a standard consumer analysis system and classification system; (3) provides the retailer with a system of classifying and categorizing inventory and their customer base, e.g., used for marketing and buying purposes; (4) provides a database of classification categories for features of clothing, and associated retail products, and for human styling characteristics; (5) provides a matching directory for clothing, associated retail product and human styling characteristics; and (6) provides a unified system for local, or international, on-line or in-store automatic product identification, matching and purchasing.

The CLASS system 1000 includes a series of databases—as described above—and programs that classify, categorize and record clothing, accessories, and associated retail inventory (collectively referred to as the “items”) with the item parameters (referred to as “Item Style Classification Categories”, ISCCs) having the item values (referred to as “Item Style Category Options”, ISCOs) based on each item's physical and design features. The CLASS system 1000 also classifies, categorizes and records consumers' physical characteristics, personal and lifestyle activities and requirements with the personal parameters (referred to as “personal style profile Classification Categories”, SPCCs) having the personal values (referred to as “personal style profile Category Options”, SPCOs), based on a personal style and colour analysis process.

The expert rules, based on industry standards, scientific formulation and/or professional practical measures, are used to classify and match the item to the appropriate human style, thus providing a person or consumer with recommended item styles that suit their requested lifestyle, and—through the colour, fit and style selection—make them look their physical best.

The retailer provides an on-line or in-store shopping opportunity for the consumer to quickly isolate clothing they require and guarantee what has been isolated suits them. Using an in-store computer terminal, or an external computer on-line, the consumer may print out a copy of the chosen item including its location in the store. The consumer may not want a print-out, instead choosing to purchase either on-line—using an on-line purchasing system—or order the item in-store and wait for the sales staff to bring it to them at the service counter. The retailer can fine tune their buying module and target market their inventory to their customer database and the broader market.

In some embodiments, the personal style profile for each person is stored in an online personal style profile in the CLASS Central Hub, in particular in the Central Consumer Style Profile Database 1e and one or more retailer customer databases 1g,1k. Alternatively or additionally, a Universal Serial Bus (USB) Key, or other portable storage medium, is issued to the consumer after their styling analysis, which holds their personal style profile and personal information, and allows the consumer to upgrade their personal style profile. The program also allows the personal style profile of the consumer's family and friends to be included. The online personal style profile and/or the USB Key provide the consumer with the ability to use their personal style profile in-store at any CLASS retailer worldwide. The consumer can also download their personal style profile onto a hard drive of the consumer's computer 13.

For a consumer who does not have a personal style profile, but would like to test or trial the system, there is an opportunity to do so through a Create Your Own personal style profile (CYOPSP) Program of questions. The CYOPSP is a temporary personal style profile that lasts for only one time (e.g., for one shopping process, online or in-store), and for a limited period of time (e.g., for up to three months).

The CLASS system 1000 uses and provides a standardized format and training service to all areas of the business including the stylist (either in-store or working as an independent), the retailer (on-line or in-store), the supplier and the consumer.

The consumer access program can change from culture to culture considering different dress codes, climates and ethical standards across the world, however the personal colour and physical analysis remains the same for all humans. Personal information and lifestyle questions, and possible answers, are associated with climate and cultural issues.

The CLASS Head Office (i.e., The CLASS system management) receives constant industry updates in technology, development and fashion trends that may impact on the buying direction of the retailer and consumer, and these upgrades are added to the system on a regular basis.

Architecture

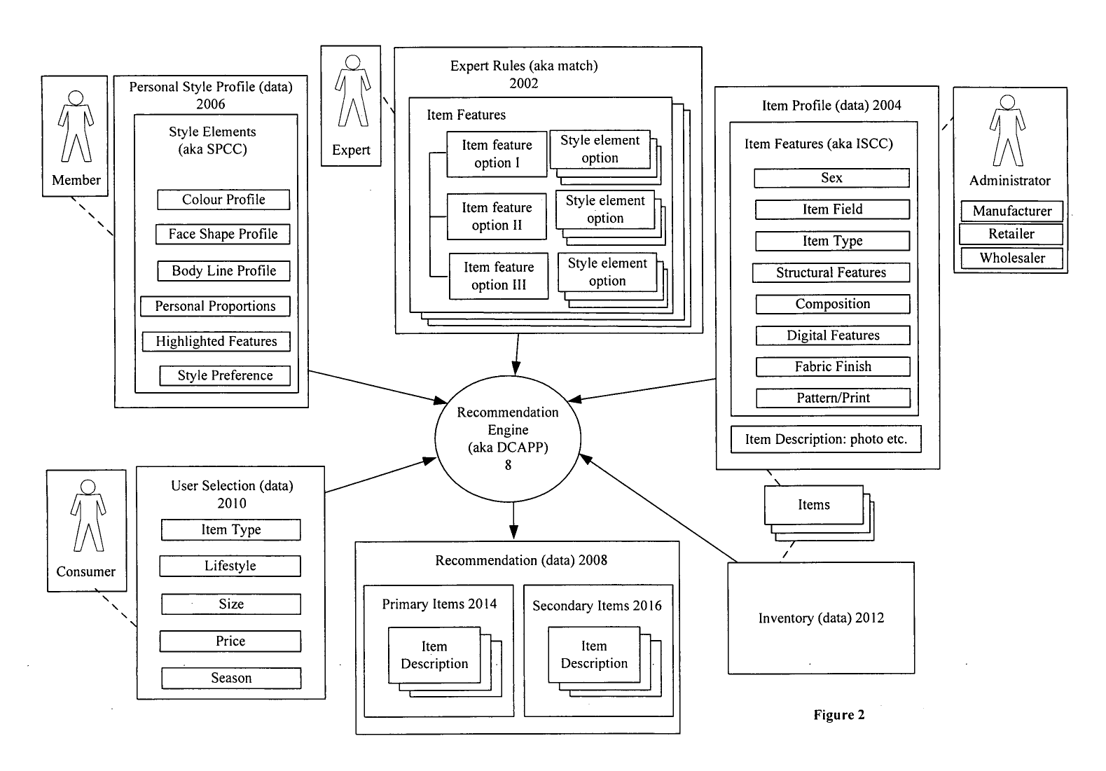

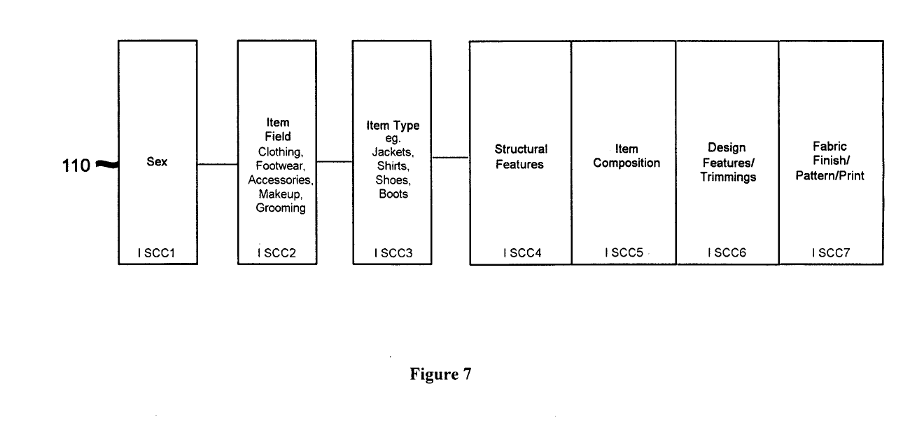

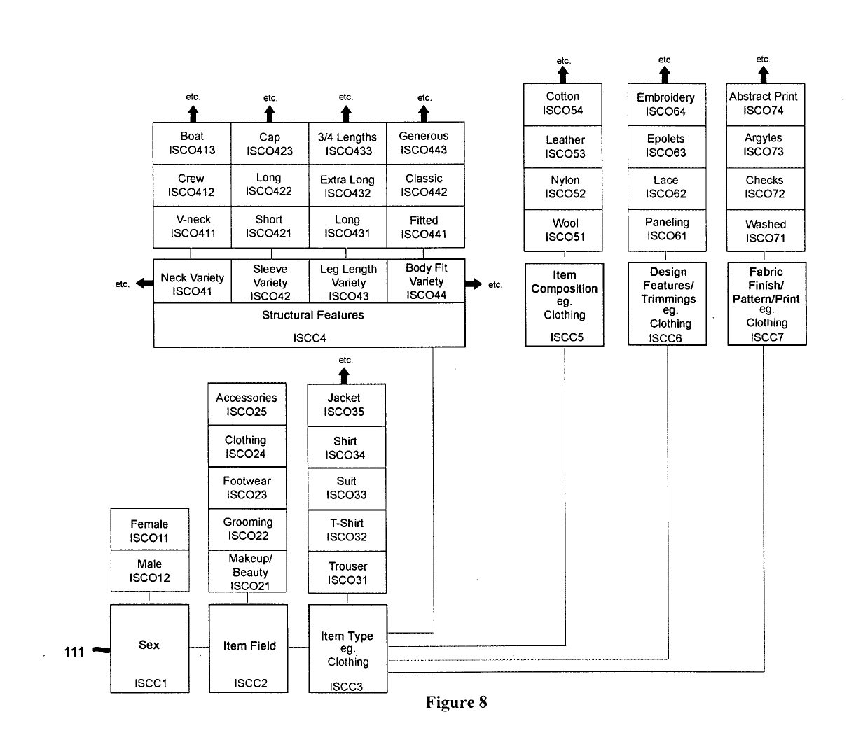

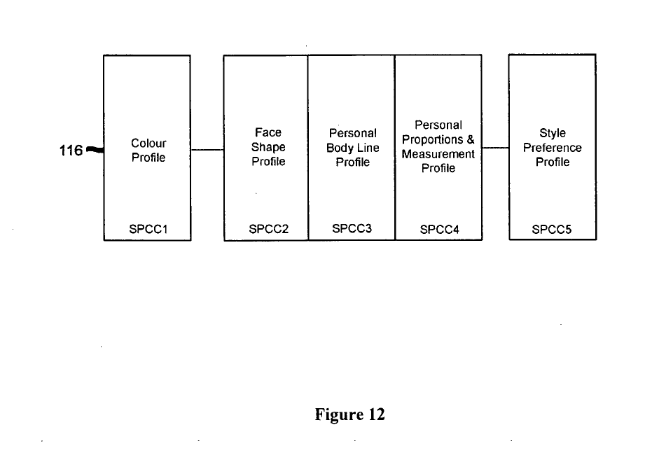

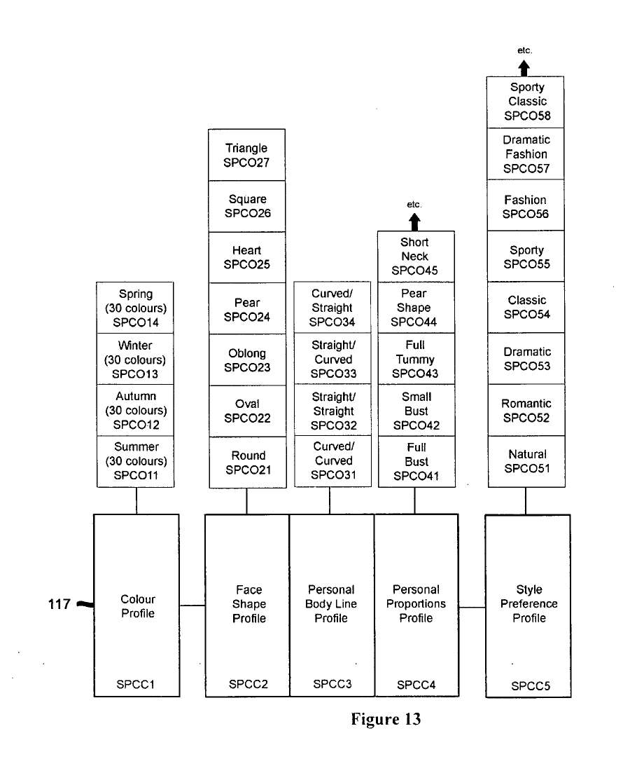

The CLASS system 1000 includes a recommendation engine, referred to as the Daily Consumer Access and Purchasing Program (DCAPP) 8, of the style system 1002, which applies expert matching rules 2002 in the expert rules database 1008 to the item profile data 2004 (in the item profile database 1006) and personal style profile data 2006 of a member to generate recommendation data 2008 representing recommended items. As shown in FIG. 2, the item profile data 2004 includes, for each item, a range of item features listed as the ISCCs, further described below with reference to FIG. 7. The item profile data 2004 also includes a description of the item, including a photograph etc. The personal style profile data 2006, for each member, includes style elements or features of a personal style which are known as Style Profile Classification Categories (SPCCs), which are described below with reference to FIGS. 12 and 13. The recommendation engine, or the DCAPP 8, recommends items based on the personal style profile using the expert rules 2002. A consumer, which may also be the member, or another person with the member's personal style profile data 2006, makes a user selection by generating user selection data 2010. This selection may, for example, include defining an item type, a lifestyle, a size, a price and a season, and providing the DCAPP 8 with the personal style profile data 2006 of the member. Each available item listed in inventory data 2012 (in the inventory database 1004) has an item record in the item profile data 2004 where values for all of the item features or item parameters (known as “Options” for the “ISCCs”) have been pre-defined (e.g., by an administrator, or purchaser of goods for the inventory). The expert rules 2002 identify, for each item, which personal style options (i.e., values, known as “options”, of the “style elements” or “SPCC” parameters) are appropriate or “matching”. The expert rules list, for each item feature, one or more appropriate personal style profile options. Once the DCAPP 8 has received the style element options (i.e., personal values or “SPCOs” further described with reference to FIGS. 12 and 13 below), it identifies—based on the expert rules 2002—which item feature options (i.e., item values or “ISCOs”, further described below with reference to FIG. 8) are appropriate for the particular personal style profile.

The expert rules 2002 are generated by an expert in styling, e.g., a retailer or an external style consultant.

Recommendation data 2008 generated by the DCAPP 8 includes primary items 2014, which have a primary match between item feature options and personal style options (described further hereinafter), and secondary items 2016 which match at least one primary or secondary condition (defined by the expert rules 2002). The recommendation data 2008 includes descriptions of the primary and secondary items including photographs, as further described hereinafter.

The Central Item Classification Database 1d includes the item records, with a unique number or code for referring to each classified item associated with a manufacturer/wholesaler/retailer/reorder code for the item. The Central Consumer Style Profile Database 1e includes the personal records, with a unique name or nickname associated with each personal style profile.

Item Recommendation Process 3000

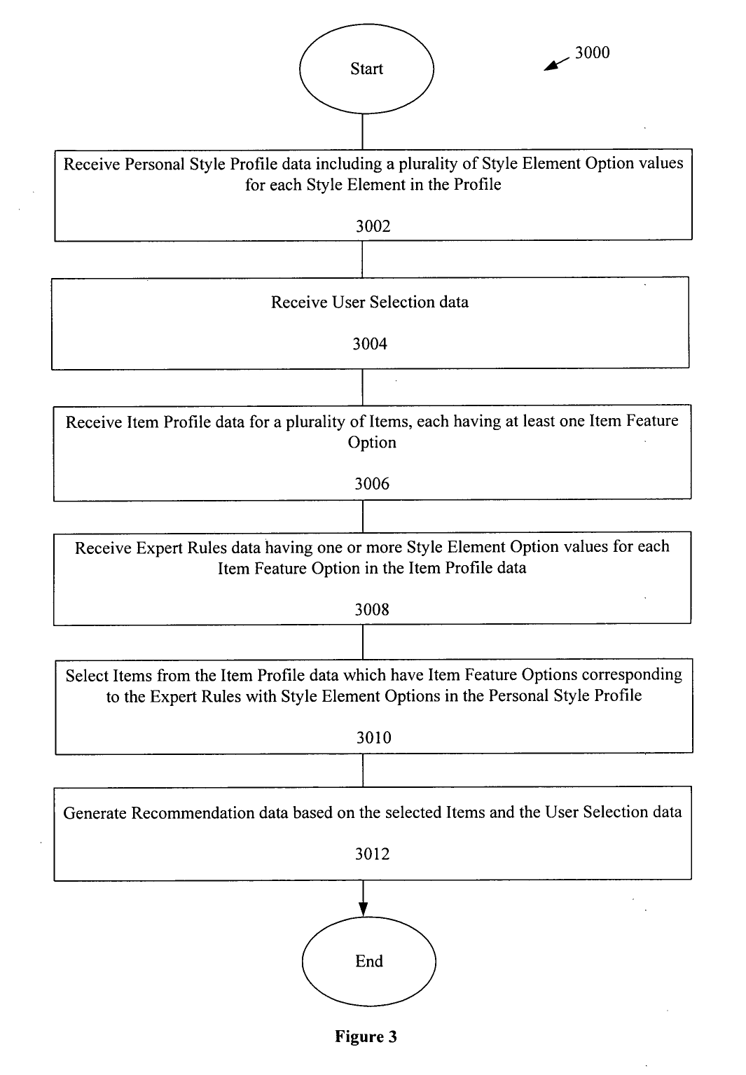

The DCAPP 8 performs a recommendation process 3000, which commences with the DCAPP 8 receiving personal style profile data, including a plurality of style profile category options (SPCOs) for each style element (or SPCC) in the profile (step 3002), as shown in FIG. 3. The DCAPP 8 also receives the user selection data 2010 (step 3004) and the item profile data 2004 for the items available in one or more relevant inventories (i.e., in the inventory database 1004) in step 3006. The DCAPP 8 accesses the expert rules 2002 to receive expert rules data with one or more style element options (or SPCOs) for each item feature option (or ISCO) in step 3008. The DCAPP 8 then selects items listed in the inventory which have item feature options corresponding to the item feature options of the expert rules that have their style element options in the personal style profile data 2006 of the member (step 3010). That is, the DCAPP 8 uses the expert rules 2002 to determine which item feature options match the personal style profile data 2006 and to generate the recommendation data (representing one or more recommended primary items 2014 and secondary items 2016) based on the selected items and any further relevant user selections in the user selection data 2010, e.g., a limitation based on price (step 3012). The recommendation data can include numbers or codes corresponding to each item. The recommendation data can be limited to item(s) listed in the inventory database 1004.

In-Store CLASS System 400 and Online CLASS System 500

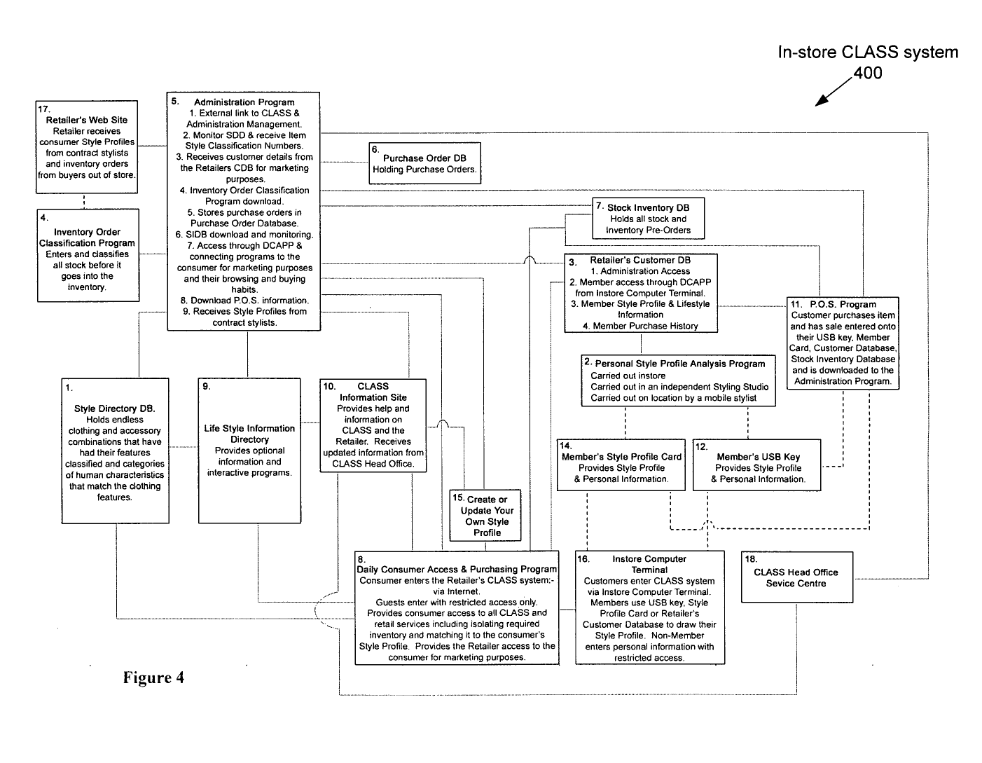

In an in-store CLASS system 400, a Style Directory Database (SDD) 1, as shown in FIG. 4, holds combinations of clothing and accessory features that exists in a retailer's inventory, including the expert rules 2002 and combinations of human styling characteristics, as are required to match to the inventory. The SDD 1 is regularly updated to account for new technology and retail requirements.

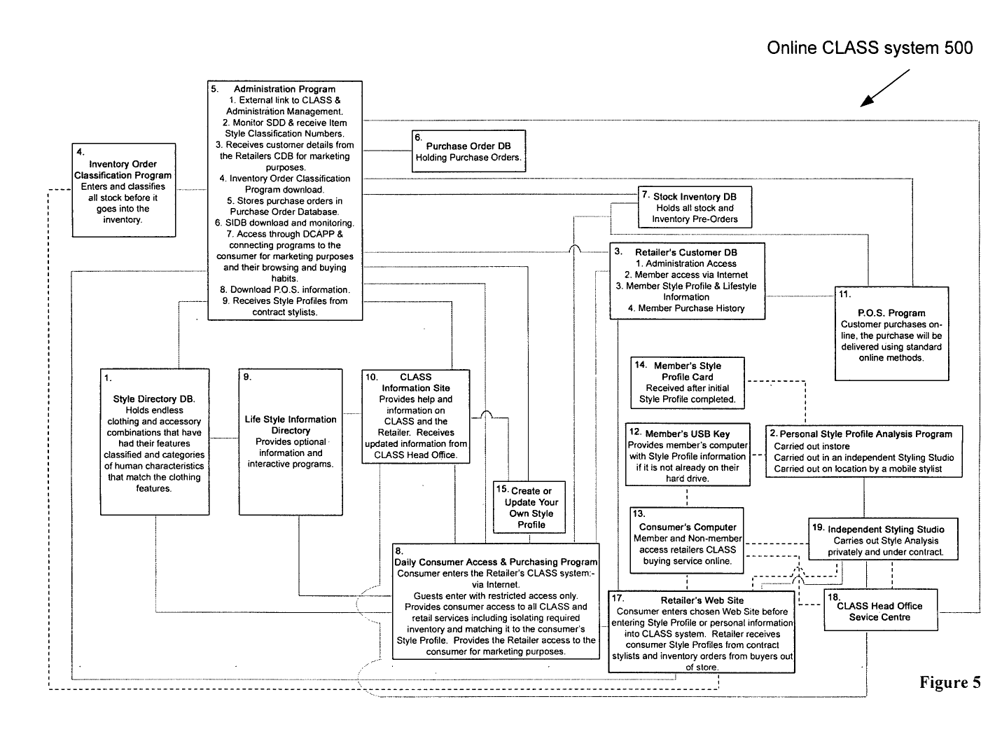

In an online CLASS system 500, the consumer accesses the CLASS system 1000 via the retailer's website 17, shown in FIG. 5. The personal style profile is retrieved from the online personal style profile, the USB Key, or downloaded directly from the Consumer's Computer 13 (e.g., that has received a copy of the personal style profile downloaded from the online personal style profile or the USB Key). A member who does not have access to their personal style profile on the online personal style profile, the USB Key, or on the Consumer's Computer 13, can retrieve it from a Retailer's Customer Database 3 (which includes the retailer's customer databases 1g,1k) using the DCAPP 8.

The Retail and Web-Based software applications work in very similar ways, with similar internal programming: the differences lie in the location of the personal style analysis done and the different processes of entry, exit and purchase.

The personal style profile is generated for the customer in a personal style profile analysis program 2 using a personal input module of the CLASS system 1000.

The DCAPP 8 allows the user to use the CLASS system 1000. The DCAPP 8 uses the SDD 1 to isolate user item requests and match the member's personal style profile characteristics.

The In-store Computer Terminal 16 uses the personal style profile from the member's personal style profile card 14 or the USB Key or the online personal style profile.

A non-member may access the In-store Computer Terminal 16 and follow the prompts for access to the CLASS system 1000. A member without their USB Key available, but wishing to use the Retailer's Customer Database 3 to obtain their personal style profile, may also accesses the CLASS system 1000 via the In-store Computer Terminal 16. The In-store Computer Terminal 16 directs an authorised consumer to access the online personal style profile or to enter personal data using the DCAPP 8.

Non-members can create a temporary personal style profile through the Create or Update Your Own personal style profile module 15, which gives them an understanding of the CLASS system 1000 and provides their details to the Administration Program 5 for marketing purposes.

An input software program is provided by an item input module and a rules input module in an Inventory Order Classification Program 4, which is used by the retailer, and other item originators (e.g., manufacturers, distributors, importers, etc.), to classify each new item of inventory, such as when ordering new stock, before the stock is entered into the retailer's inventory system by the Administration Program 5. Once the Administration Program 5 has received an order, it is processed, relevant order information is sent to a Purchase Order Database 6 and other relevant order and vendor information is used by the Administration Program 5 for administration and management. When the stock arrives it is checked off and the order is generated, or ‘drawn’, from the Purchase Order Database 6 by the Administration Program 5, and then this data is sent to the Central Item Classification Database 1d and/or one or more Inventory Databases 1h,1l (also referred to herein, and shown in the Figures, as at least one “Stock Inventory Database 7”). The Administration Program 5 may send a pre-order to the Central Item Classification Database 1d and/or one or more Inventory Databases 1h,1l, thus allowing the consumer to view and possibly order forth-coming stock.

A consumer requests recommendation data from the DCAPP 8 by providing user input to the CLASS system 1000, such as via a web browser on the consumer's computer or an in-store kiosk. The input may be provided to a selection or finder wizard the prompts for user input based on the item and personal parameter and values in the Item Style Directory Databases 1a and the Style Profile Directory Database 1b respectively. The web browser may be served content from the retailer's website, or the in-store kiosk, which also accesses the DCAPP 8 for generating the possible parameter values, receiving the user selections and generating the recommendations. When a consumer requests an item through the DCAPP 8, expert rule data relating to the one or more selected items are matched to any items that have also been selected by the consumer. An item photograph and the item information is sent to the DCAPP 8 for the consumer to view. The consumer chooses one or more items and may choose to receive a print-out of these items indicating and the location of the stock within a retail store (when using the In-store Application CLASS System 400). If the consumer is accessing a high street retailer's website on-line, they may print out the information and then take the information to the retailer's store to search for the item or items. Once an item is approved by the consumer for sale they can purchase the item using the POS Program 11. The consumer using the Online CLASS System 500 approves a purchase from the photograph and follows the retailer's POS Program 11 in order to purchase.

The Life Style Information Directory 9 and the CLASS Information Site 10 are consumer service modules that are accessed through the DCAPP 8.

An Independent Styling Studio 19 carries out personal style profile analyses to generate one or more personal style profiles. A new member's personal style profile is transmitted to an associated retailer from the Independent Styling Studio 19 using communication means such as a wireless communications, a wired communications network or a removable computer-readable storage device (a hard drive or flash drive). Once the associated retailer has received the new member's personal style profile information, it is sent to the Retailer's Customer Database 3. The Independent Styling Studio 19 is in communication with the CLASS Head Office and Service Centre 18, to receive regular system updates, styling and fashion news etc. The Independent Styling Studio 19 is also in communication with the Consumer's Computer 13, to provide styling, fashion or system information, including any upgrade or changes to their Style Profile.

Style Directory Database (SDD) 1

The Style Directory Database (SDD) 1 is a directory of clothing, accessory and retail inventory, human physical styling characteristics and lifestyle information. The SDD 1 includes the Item Style Directory Database 1a, the Style Profile Directory Database 1b, the Life Style Directory Database 1c and the Expert Rules Database 1008, and stores the Item Profile data, the personal style profile data, and the expert rules.

The Item Profile data includes Item Feature data, which represents the features (or “categories”) of each item as the values (“ISCOs”) of the parameters (“ISCCs”): e.g., the ‘Sex’ of a certain hat has the value ‘Male’ (this is also referred to as the hat being in the ‘Male’ category in respect of its ‘Sex’). Each unique set or combination of the values is represented by a ‘Item Style Classification Number’, thus a plurality of hats with the same values for all corresponding parameters is represented in the same number.

The personal style profile data includes Personal Feature data, representative of appropriate human styling characteristics. The Personal Feature data represents the values of the parameters (referred to as “personal style profile Classification Categories” or SPCCs) for any given consumer, analogously to the Item Feature data for items. For example, the ‘Colour Profile’ parameter of a certain member has the value ‘Summer’ (this is also referred to as the member being in the ‘Summer’ category in respect of his or her ‘Colour Profile’).

Any modules of the CLASS system 1000 that use inventory, or consumer based information, use the format for Item Profile data and personal style profile Data from the SDD 1.

The SDD 1 is updated with new fashion, textile, trend, technology or design updates in an on-going or continual manner. New categories (i.e., parameters) may need to created and matched (in the expert rules 2002) to existing or new categories. Other modules in the CLASS system 1000 are also updated as the new categories, for Item Profiles or personal style profiles, are created.

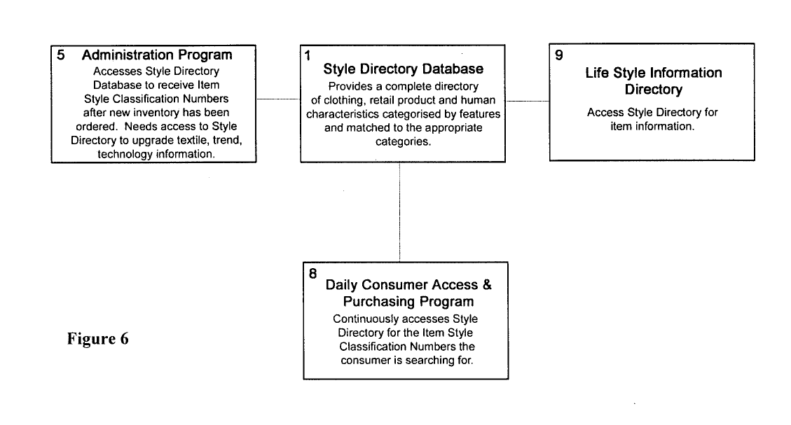

Three modules use the SDD 1 on a continuing basis, as shown in FIG. 6: (i) the Administration Program 5; (ii) the Life Style Information Directory 9; and (iii) the DCAPP 8.

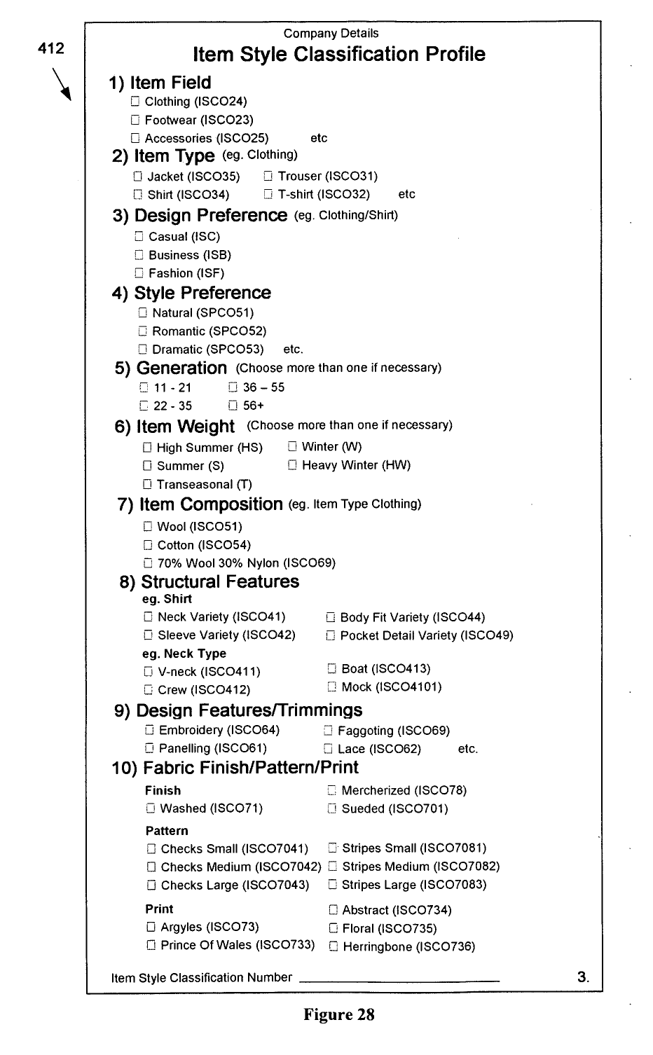

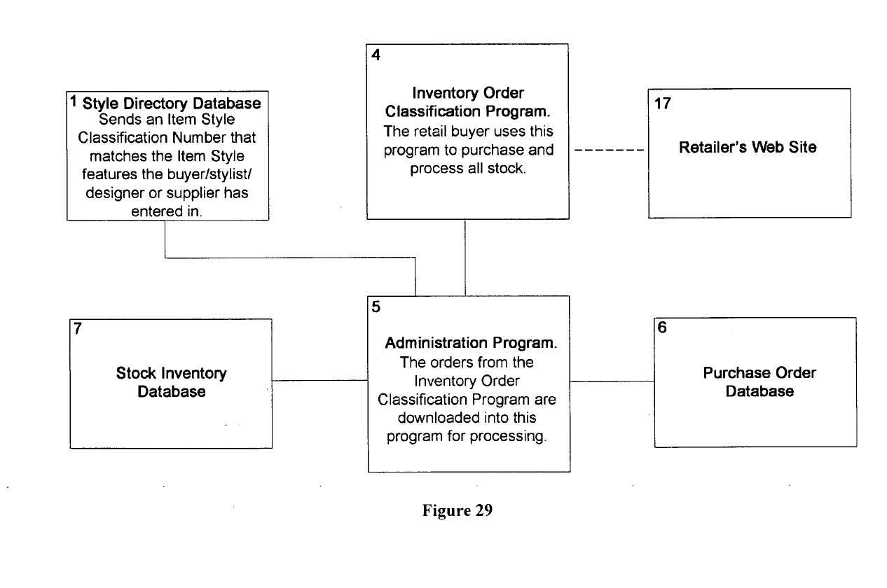

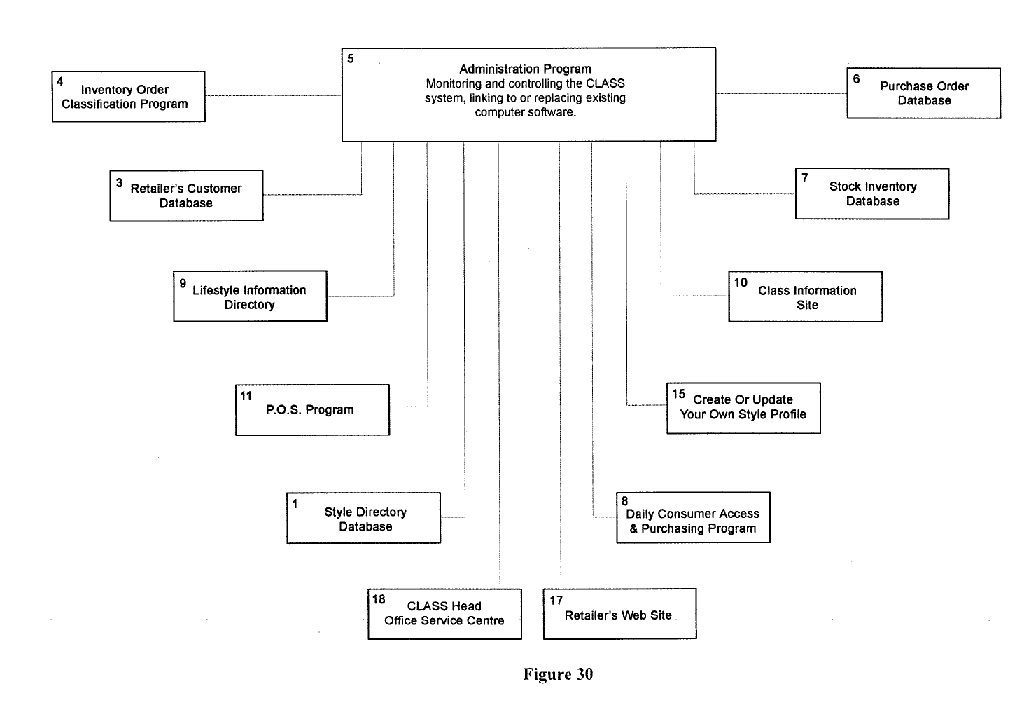

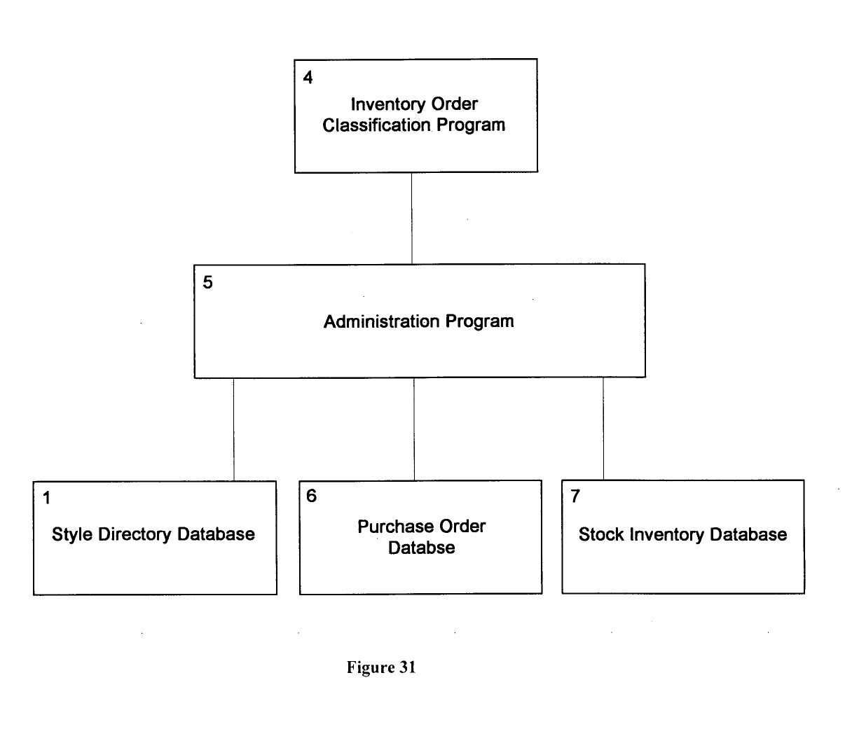

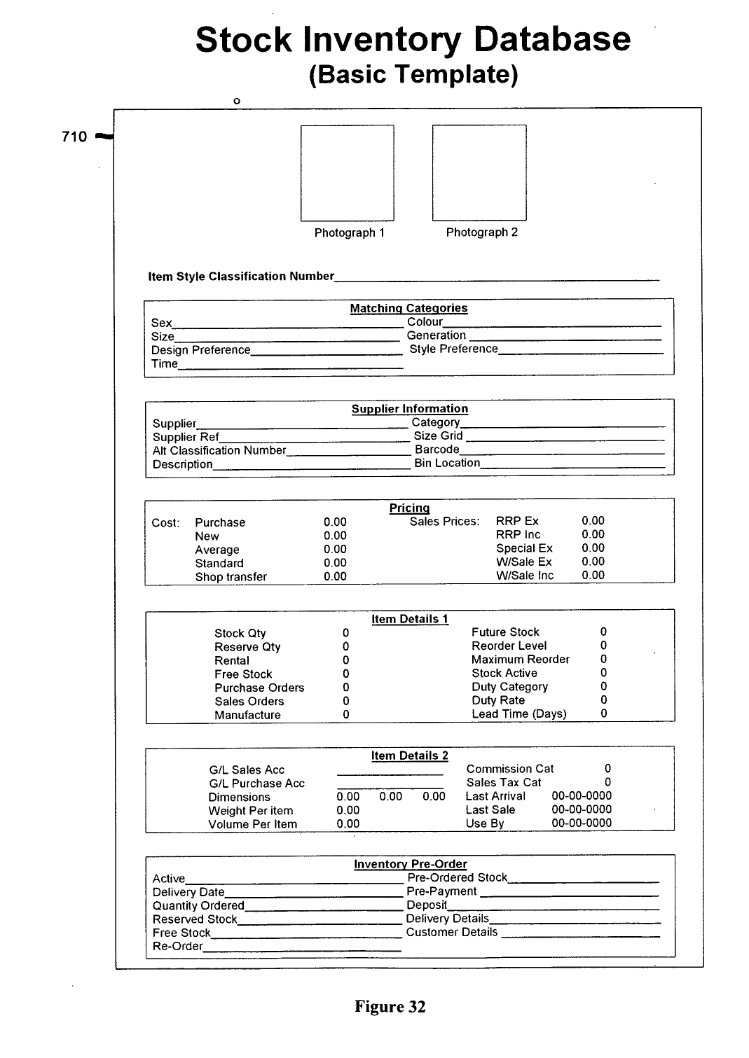

The Administration Program 5 allows for generation and transmission of any fashion, technology, trend or design upgrades to the SDD 1. The Administration Program 5 also accesses the SDD 1 when an inventory order has been received and the individual items (which have already been categorized using the Inventory Order Classification Program 4) need to have an Item Style Classification Number allocated to them. The Administration Program sends an item template (e.g., as shown in FIG. 28) with all the new items' categories completed.

The Life Style Information Directory 9 has a number of consumer service programs that access data in the clothing database of the SDD 1.

The DCAPP 8, when used by a consumer wishing to view their personal style profile to view and match the inventory of a retailer, accesses the SDD 1.

Search/Matching Process of the CLASS System

When a consumer accesses the CLASS system 1000, they use the DCAPP 8 using their personal style profile or a temporary personal style profile created from the Create Or Update Your Own personal style profile 15. Their personal style profile has categorized them into the basic categories Sex and Generation (see FIG. 22), and style categories Colour, Face Shape, Personal Body Line, Proportions, and Style Preference (see FIG. 13). When shopping or browsing, the consumer answers a series of questions, and thereby chooses Item Field and Type categories such as Clothing and Trouser (see FIG. 7). Once the consumer chooses the item categories to search for, the DCAPP 8 uses Classification Category Code Numbers, related to these item categories, to search the SDD 1 for the same Classification Category Code Numbers, and thus corresponding items. One or more item Style Classification Numbers with the chosen Item Field and Type categories are isolated by the DCAPP 8. The Item Style Classification Numbers that represent item styles the consumer has requested, and matched by their personal characteristics, are drawn out of the SDD 1 and sent to the Inventory Databases to match stock.

Item Style Classification Categories (ISCCs)—Item Parameters

The item parameters, or ISCCs, provide a directory of clothing and accessory features, classified by parameters such as structure, design, trimming, textile composition and finish. The items' features are in six principle categories, ISCC2 to ISCC7, as shown in FIG. 7.

The item parameters each have a plurality of values (referred to as “Item Style Category Options”), as shown in FIG. 8, which vary in purpose, structure and usage. The number of values (also referred to as “options”) for each parameter (also referred to as being within each ISCC) varies in number: e.g., the parameter ‘Sex’ (“ISCC1”) has two possible values, the parameter ‘Design Features/Trimming’ (“ISCC6”) has hundreds of possible values, e.g., as shown for Items 113 and 113A with both ‘Embroidery’ (ISCO64) and ‘Epaulets’ (ISCO63) in FIG. 10. Certain parameters have values that may be grouped in sub-parameters, e.g., parameter ‘Structural Features’ (“ISCC4”) has sub-parameters such as ‘Neck Variety’ and ‘Sleeve Variety’, etc.

The set of possible item values available for each parameter can be tailor made, or limited, to suit particular retailers. For example, a conservative men's boutique does not need access to the same range of item parameter values as a department store, or high fashion boutique that carries labels such as Dolce and Gabana, particularly in Item Style Categories such as ISCC6 ‘Design Features/Trimmings’.

As shown in FIGS. 7 and 8: (1) item parameter ‘Sex’ (ISCC1) has two possible values ‘male’ (ISCO11) and ‘female’ (ISCO12); (2) item parameter ‘Item Field’ (ISCC2) provides for distinguishing retail product groups that are physically used by humans for their lifestyle, and has five possible values: e.g., ‘Clothing’, ‘Footwear’, ‘Accessories’, ‘Makeup’, and ‘Grooming’ (ISCO21 to ISCO25). Not all Items require a value for every parameter: e.g., some Item Types other than clothing may only require two or three Options; (3) item parameter ‘Item Type’ (ISCC3) provides a representation of retail product types and has possible values such as: ‘Trouser’ (ISCO31), ‘T-Shirt’ (ISCO32), ‘Suit’ (ISCO33), etc.; (4) item parameter ‘Structural Features’ sub-divides into item sub-parameters such as ‘Neck Variety’ (ISCO41)—with possible values of ‘V-neck’ (OSCP411), ‘Crew’ (ISCO412), ‘Boat’ (ISCO413), etc.—and ‘Sleeve Variety’ (ISCO42)—with possible values of ‘Short’ (ISCO421), ‘Long’ (OSCP422), ‘Cap’ (ISCO423), etc.; (5) item parameter ‘Item Composition’ (ISCC5) provides a representation of different textile compositions: e.g., different fabric choices, weights and combinations for clothing; (6) item parameter ‘Design Features and Trimmings’ (ISCC6) provides a representation of industry design features and trimmings, e.g.,; (7) item parameters ‘Fabric Finish/Pattern/Print’ (ISCC7) provides a representation of fabric finishes, patterns and prints, e.g., relating to Clothing, with values such as ‘Washed’ (ISCO71), ‘Checks’ (ISCO72), ‘Argyles’ (ISCO73) and ‘Abstract Print’ (ISCO74).

Item Style Classification Numbers

An Item Style Classification Number for each Item is part of a numbering scheme used to identify unique categories of item values, allowing each item that can be differentiated by the CLASS system 1000 to be uniquely referred to and represented by a number (or some code). Three example Items 113, 113A and 114, and their respective numbers, are shown in FIG. 10. The Items 113 and 113A illustrate how one change in a value, e.g., from ‘Abstract Print’ to ‘Argyles’, changes the Item Style Classification Number, e.g., from ‘ISCN2913’ to ‘ISCN2914’. Item 114 has only eight Category Options corresponding to its classification number. The SDD 1 uses an Item Style Classification Numbering System 115, in which each unique clothing and accessory combination is allocated an Item Style Classification Number. A photograph of each Item is entered into the retailer's inventory, and is used by the CLASS system 1000 to display each item and its features to the user.

Updates

The available item sub-parameters and the available values for certain parameters are updated regularly by the Administrator based on new fabric features, design features or changing fashion trends. A new item value can be added by the Administration Program 5. The Administration Program 5 also regularly updates the SDD 1, the Inventory Order Classification Program 4 and the Life Style Information Directory 9 with any new item values: e.g., a monthly update is automatically sent out to all components of the CLASS system 1000.

Personal Style Profile Classification Categories (SPCCs)—Personal Parameters

A second set of parameters is the set of personal parameters, referred to as “SPCCs”, representing a directory of human styling characteristics analysed and classified by colour, face, body shape, style preference, etc. The creation of a new personal style profile for a consumer can provide an opportunity to technically, scientifically and practically analyse, separate and allocate with continuity the necessary characteristics used for styling.

There are typically five personal parameters: four relate to physical characteristics, and one to style preference, as shown in FIG. 12. The personal parameters are filled with one or more possible personal values (also referred to as “personal style profile Category Options”), as shown in FIG. 13. The personal values are selected in a personal style profile generation process to allow matching to items with the most suitable colour, design and set of clothing and accessory features. All five personal parameters are used by the personal style profile analysis program 2 in templates to classify physical characteristics of the customer. Each personal parameter, and its corresponding values are referred to using a number or a code from ‘1’ to ‘5’ allocated as prefix of each “Category Options”.

As shown in FIG. 12, are: (1) personal parameter ‘Colour Profile’ (SPCC1) has four possible values, as shown in FIG. 13: ‘Summer’ (SPCO11), ‘Autumn’ (SPCO12), ‘Winter’ (SPCO13) and ‘Spring’ (SPCO14); (2) personal parameter ‘Face Shape Profile’ (SPCC2) is used to separate the different types of members' face shapes based on seven possible values, as shown in FIG. 13: ‘Round’ (SPCO21), ‘Oval’ (SPCO22), ‘Oblong’ (SPCO23), ‘Pear’ (SPCO24), ‘Heart’ (SPCO25), ‘Square’ (SPCO26) and ‘Triangle’ (SPCO27); (3) personal parameter ‘Personal Body Line Profile’ (SPCC3) has four possible values, as shown in FIG. 13 for separating the different body lines exhibited by people: ‘Curved/Curved’ (SPCO31), ‘Straight/Straight’ (SPCO32), ‘Straight/Curved’ (SPCO33) and ‘Curved/Straight’ (SPCO34); (4) personal parameter ‘Personal Proportions Profile’ (SPCC4) has over ten values, as shown in FIG. 13: ‘Full Bust’ (SPCO41), ‘Small Bust’ (SPCO42), ‘Full Tummy’ (SPCO43), ‘Pear Shape’ (SPCO44), ‘Short Neck’ (SPCO45), etc.;. (5) personal parameter ‘Style Preference Profile’ (SPCC5) has personal values that are referred to as “major” values and/or “minor” values, including six major values (SPCO51 to SPCO56) and a number of minor values (SPCO56, SPCO57, etc.), as shown in FIG. 13.

The ‘Style Preference Profile’ parameter has values that represent the type of personality the consumer is and the style of clothing they wear. A person primarily corresponds to one or more values of this parameter (“in this category”), e.g., “Sporty”, or “Sporty” and “Dramatic”, etc. The ‘Style Preferences Profile’ parameter data is not necessarily used to match clothing features like the values of the other personal parameters, but are part of the ordering programs and Inventory Databases; it can be difficult to select a value for the ‘Style Preferences Profile’ parameter for individual garment features, but it can be possible to assess this value for the garment as a whole. It can, therefore, be preferable to allow a consumer to select the ‘Style Preference Profile’ parameter value when ordering.

The Expert Rules 2002—Links

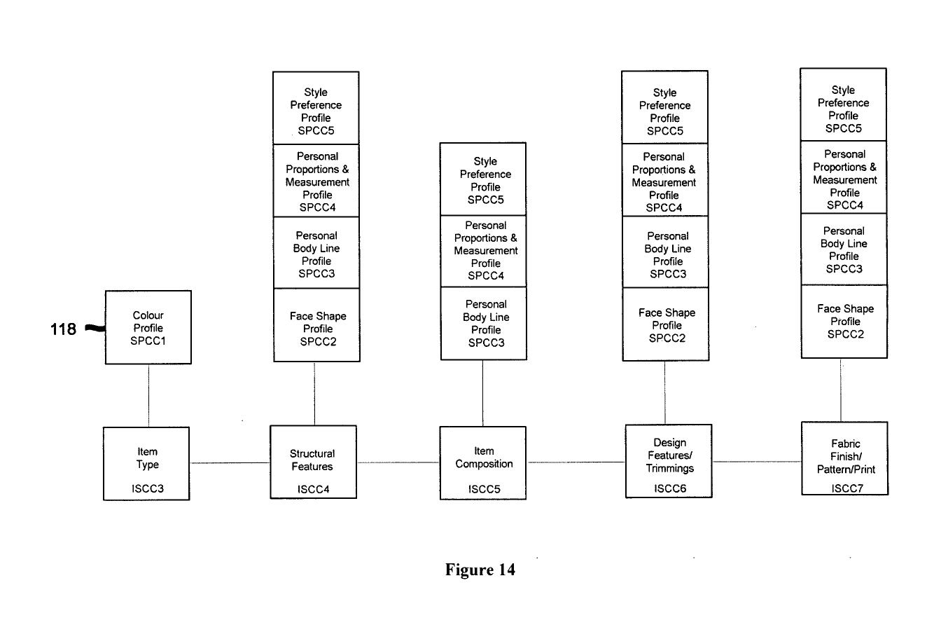

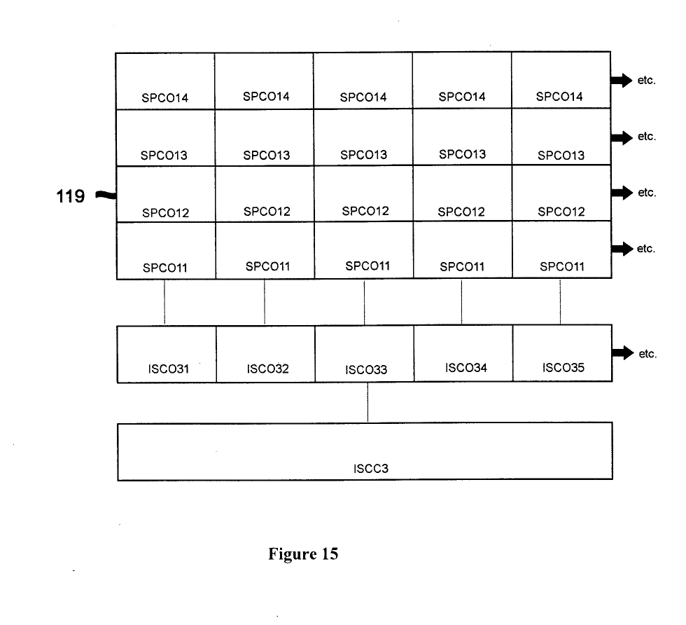

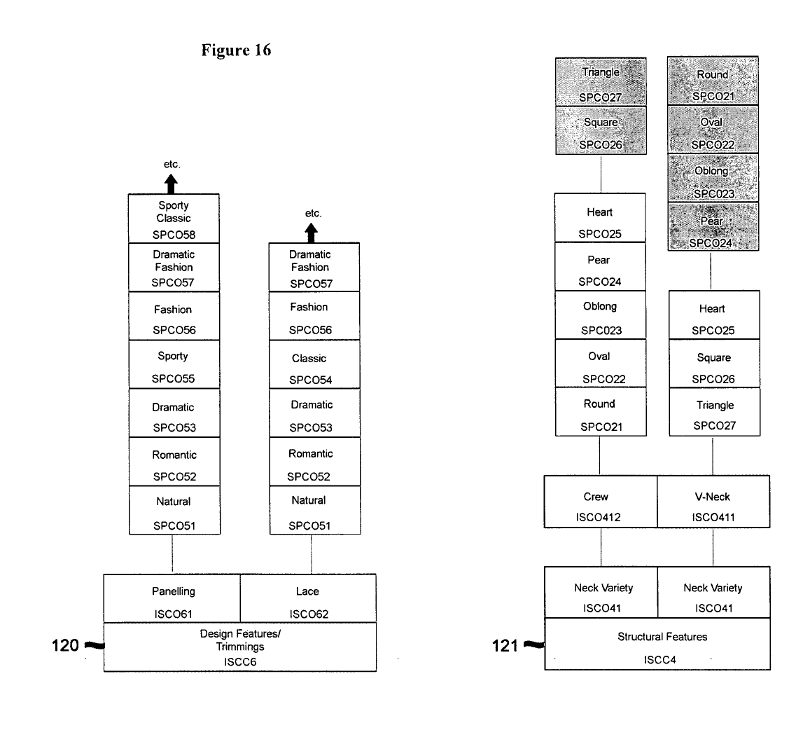

The personal values are used to match, or select, particular items based on their item values. The expert rules 2000 (also referred to as “links” or matching rules) provide, for each item value (“ISCO”) (corresponding to a feature of the item), links to one or more personal values (“SPCOs”), e.g., as shown in FIG. 14. For example an item that is a trouser with an item value ‘Trouser’ (ISCO31), is linked to all four of the following personal values, as shown in FIG. 15: ‘Summer’ (SPCO11), ‘Autumn’ (SPCO12), ‘Winter’ (SPCO13) and ‘Spring’ (SPCO14). One personal value may be linked to multiple item values, e.g., the personal value ‘Natural’ (SPCO51) is linked to both item values ‘Panelling’ (ISCO61) and ISCO ‘Lace’ (ISCO62), as shown in FIG. 16. Some item values are only linked to one personal value, e.g., item value ‘Panelling’ (ISCO61) corresponds to personal value ‘Sporty’ (SPCO55) whereas item value ‘Lace’ (ISCO62) does not.

The expert rules 2002 also provide, again for each item value, links to one or more secondary personal values, e.g., as highlighted in grey in FIG. 16. The secondary set of linked personal values allows a secondary set of items that do not directly match a person's physical characteristics but may be acceptable (e.g., may be all that is available from a particular retailer, or be something they are searching for). In an example Expert Rule 121, as shown in FIG. 16, a person with a square or triangular face shape, i.e., having personal values of ‘Square’ (SPCO26) or ‘Triangle’ (SPCO27)) is not matched directly to a crew neck garment (item value ‘Crew’ ISCO412), whereas a person with a round or oval face shape (i.e., personal value ‘Round’ SPCO21 or ‘Oval’ SPCO22) is not matched to a v-neck (i.e., item value ‘V-Neck’ ISCO411) garment. If a consumer is looking for a shape of neck that does not match their personal style profile, they can access a secondary set option to find the neck they require. The matching of a personal profile to one or more items by the expert rules 2002 is thus not restricted to only “black and white”, or exact, matching situations. For example, Design Features such as ‘embroidery’ can be appropriate for ‘Classical’, ‘Dramatic’, ‘Romantic’, ‘Sporty’ and ‘Natural’ Personal Styles.

Highlight Option

The CLASS system 1000 generates preferred appearance profile data which allows for a person to wear particular styles to highlight or hide a particular physical feature. For example, one person may wish to de-emphasise large breasts or long legs whereas another person may wish to highlight them. This information is included in the personal style profile.

Lifestyle Categories

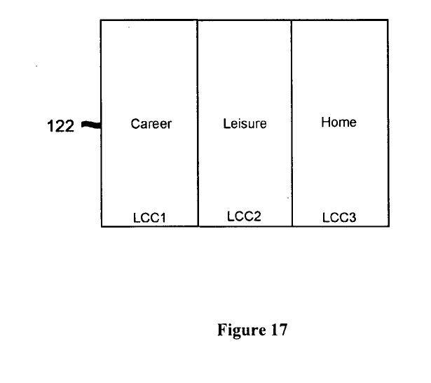

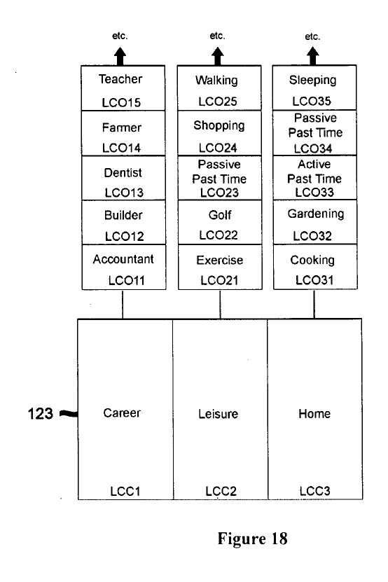

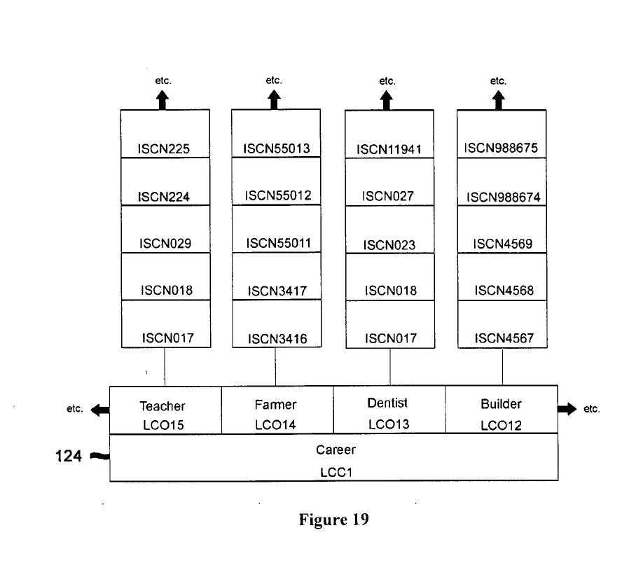

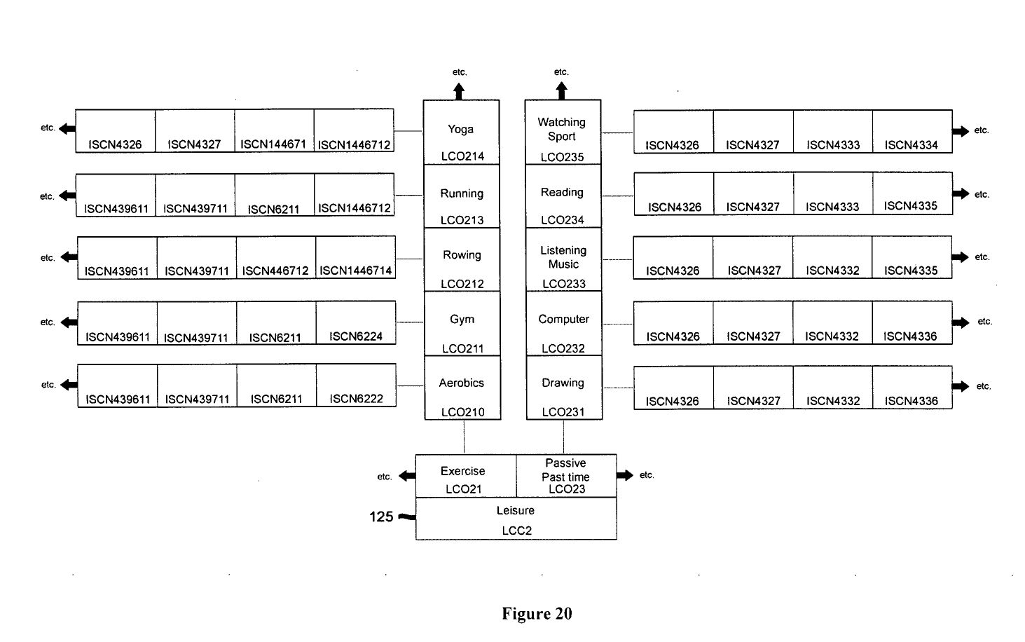

The SDD 1 also includes item parameters (referred to as “Lifestyle Classification Categories” LCCs) 122 relating to a person's lifestyle, including: ‘Career’ LCC1, ‘Leisure’ LCC2 and ‘Home’ LCC3, as shown in FIG. 17. The Lifestyle Categories are used within the DCAPP 8 by a consumer wishing to view clothing that is matched to a particular Lifestyle activity. The Lifestyle Categories may also be used in the personal style profile analysis program 2 if a new member would like to see during their initial consultation the clothing that suits their Lifestyle activities such as their job or leisure activity using their new personal style profile Information. Each Lifestyle Classification Category includes one or more item values (referred to as “Category Options”), and each Lifestyle Category Option corresponds to an Item Style Classification Number: e.g., ‘Passive Pastime’ LCO23, LCO34 and ‘Active Pastime’ LCO3, as shown in FIG. 18. Certain Category Options, such as Exercise and Passive Past Time, require a second sub-category to issue Item Style Classification Numbers, e.g., LCO21 and LCO23 in FIG. 20.

Personal Style Profile Analysis Program 2

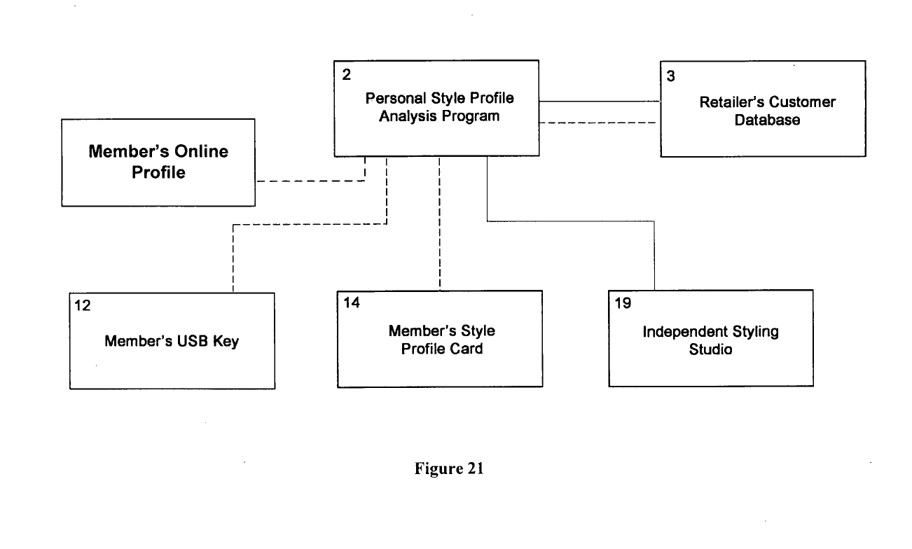

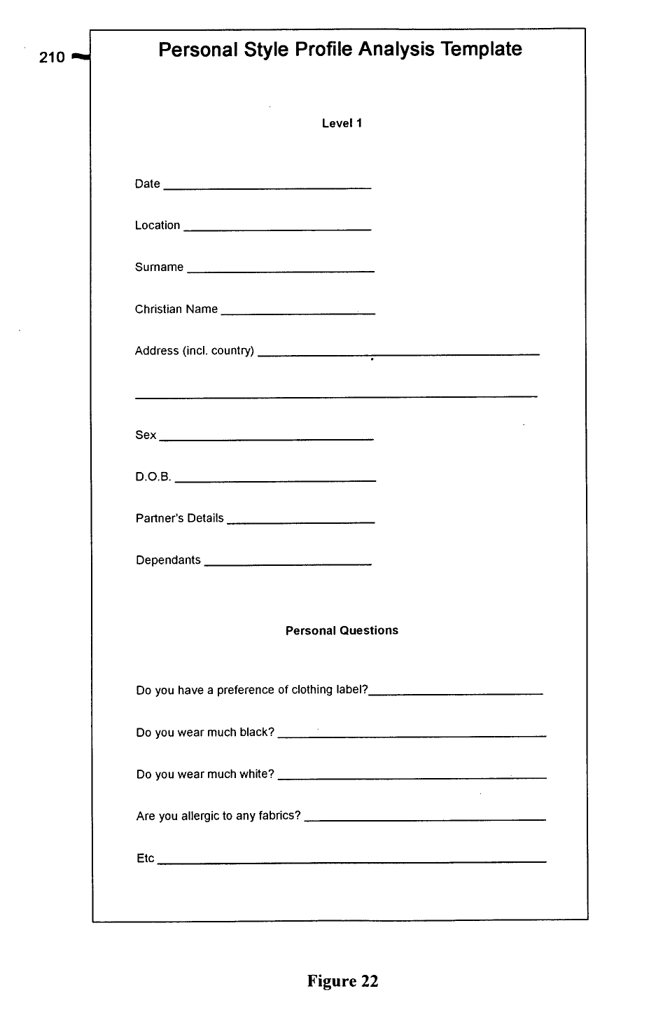

The personal style profile analysis program 2 is configured to generate a personal style profile for the customer using the personal values from the SDD 1. The personal style profile analysis program 2 is in communication with the online personal style profile, the Retailer's Customer Database 3, the USB Key, the member's personal style profile card 14 and the Independent Styling Studio 19, as shown in FIG. 21. The personal style profile analysis program 2 can be executed instore, in an independent Styling Studio, or on location by a mobile stylist.

The consumer completes a personal style and colour analysis to obtain a personal style profile and become a member of the CLASS system 1000. The personal style profile enables them to access shopping services, personal care, clothing, product and style information that match their personal characteristics and lifestyle requirements. The personal style and colour analysis can be carried out by a stylist or an image consultant trained in the CLASS styling analysis format, with a CLASS styling license, and using the CLASS styling kit with the CLASS computer program and a specific styling studio environment.

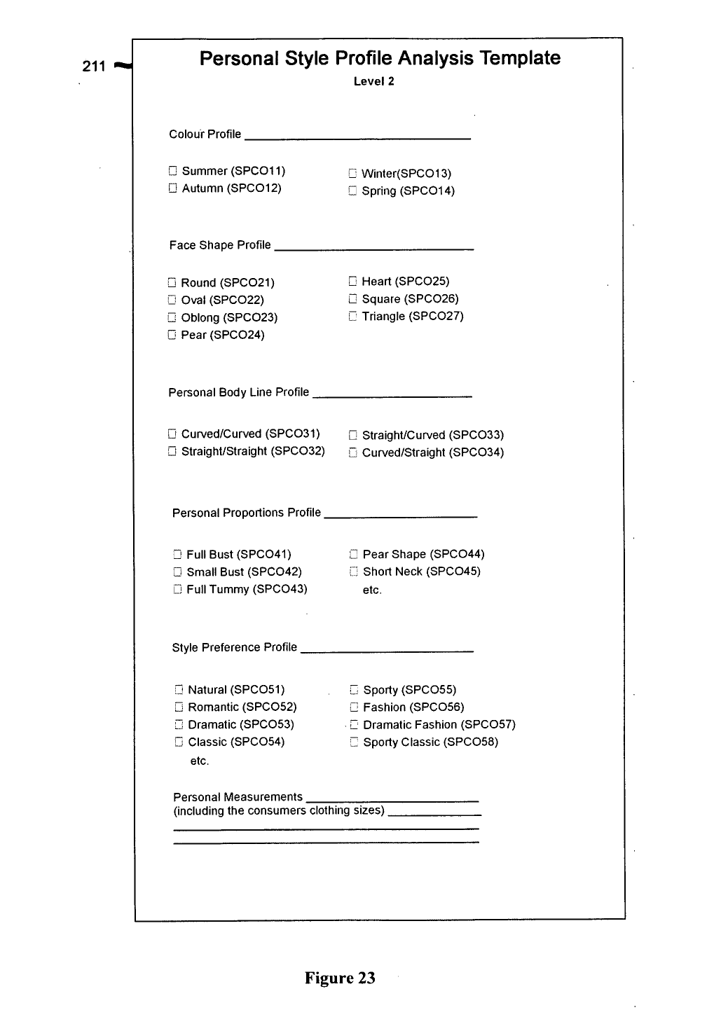

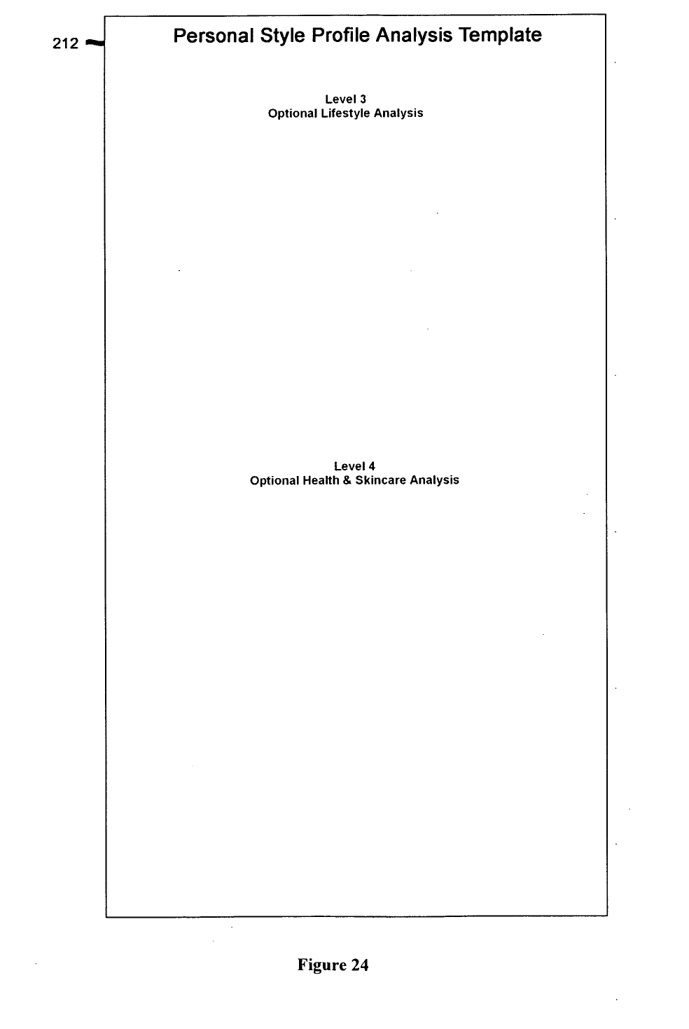

The analysis process starts off with a level 1 questionnaire 210, e.g., shown in FIG. 22, with a simple set of personal questions, required for standard security measures, family application opportunities and basic sex and generation categorization. There are some personal health and preference questions, used for marketing and personal matching applications, such as clothing label preference, allergies or reactions to particular fabric. The analysis process continues with a level 2 questionnaire 211, e.g., as shown in FIG. 23, which records the physical styling analysis of human characteristics as colouring, style preference and face and body shapes. Each individual person's results are recorded as values of the person's personal parameters. The value (or “result”) for each parameter (or “classification category”) is entered into the Personal Style Profile Analysis Template 211, and is allocated a Classification Category Code or Number used to match particular items from the SDD 1 and the Inventory Databases. The analysis process continues with a level 3 questionnaire 212, e.g., as shown in FIG. 24, which is used in the optional Life Style analysis which comprises collection of personal values relating to lifestyle. The lifestyle information includes a career or leisure option that matches the new member's personal style profile—including such things as colour, body lines and style preference—with standard system recommendations for their career or leisure requirements. The program can produce results with the member being able to view on the computer screen and print out, illustrations of total clothing outfits that suit their personal characteristics, including their colour style preference etc. The analysis process can continue with a level 4 optional Skincare analysis for make-up and grooming products. A photograph of the member may be used by the stylist to add the appropriate clothes onto the image of the consumer for the member to view.

If the personal style profile Analysis is done in a Styling Studio within a retail store, the member's personal style profile is directly downloaded into the Retailer's Customer Database 3 and the new member is able to use their online personal style profile, or their USB Key, at any retailer, including at web-based retailers that use the CLASS system 1000.

When the personal style profile analysis program 2 is run at an Independent Styling Studio 19 on behalf of a retailer (under contract), the personal style profile is sent to the retailer's website 17, and the new member is able to use their online personal style profile, or their USB Key at any retailer including web-Based retailers who use the CLASS system 1000. The independent Styling Studio sends the new member's personal style profile to the Head Office 18.

Once the personal style profile analysis program 2 has generated the personal style profile, the new member can receive a set of Sample Fabric Colour Swatches, an optional printout of their results and a number of clothing outfit combinations that suit them.

The CLASS system 1000 includes a Create Or Update Your Own Style Profile (COUYOSP) program 15, for enabling the member to upgrade their personal style profile when their circumstances change. A number of fields can be changed by the customer, e.g., name, address, career, trouser size, etc. The COUYOSP program 15 is accessed from the DCAPP 8 through the Consumer's Computer 13, or through the Instore Computer Terminal 16, or through the CLASS Central Hub.

The personal proportions and measurements of the member's personal style profile can be changed by a qualified stylist. Any upgrade or change to the personal style profile including simple member details or more detailed personal proportions, done in-store or on-line, uses the online personal style profile or the USB Key, making sure that all new details are in the new personal style profile.

The retailer can offer the consumer a temporary DIY Style Profile in the COUYOSP program 15, via the DCAPP 8. The option for the non-member to create their own personal style profile allows the CLASS system 1000 to be tested. Example questions used in the personal style profile analysis program are shown in Appendix A.

Retailer's Customer Database 3

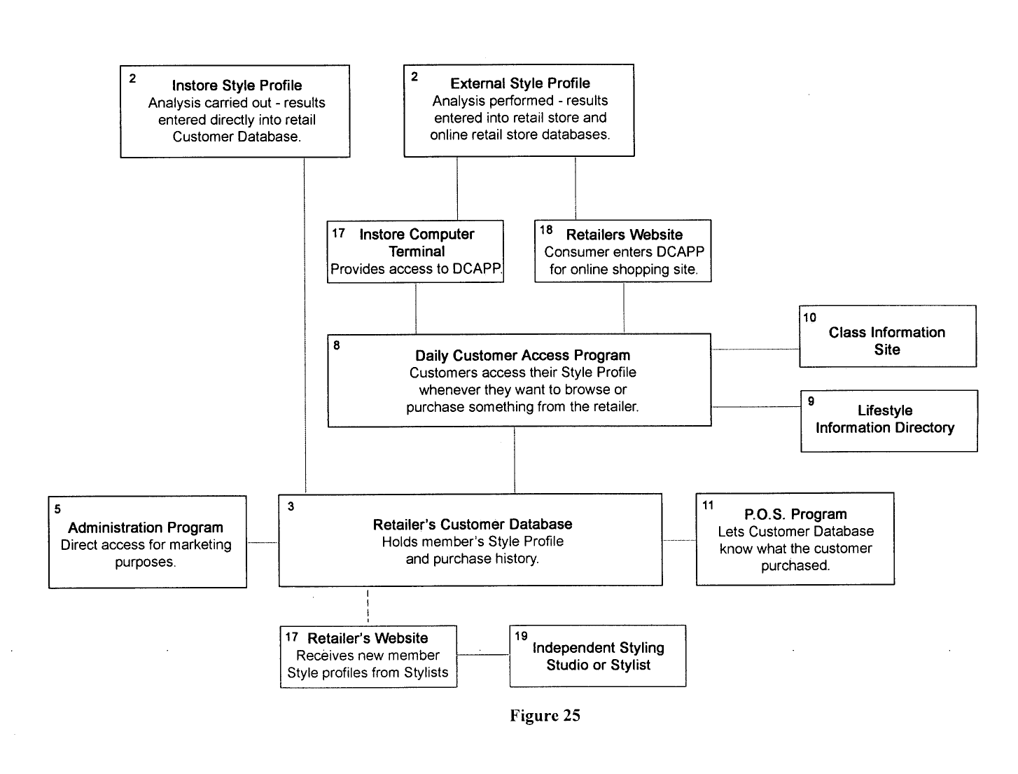

The Retailer's Customer Database 3 holds each members' personal style profile, purchase history and any other information the member has sent to the CLASS system 1000 from either the DCAPP 8, the CLASS information Site 10, or the Life Style Information Directory 9, as shown in FIG. 25. In some embodiments, the Retailer's Customer Database 3 includes the centrally stored customer databases 1g,1k, as shown in FIG. 1B. Alternatively, or additionally, the Retailer's Customer Database 3 may include database servers located on a premises of the retailer's and administered by the retailer.

The personal style profile can be entered into the Customer Database a number of ways. If the style analysis takes place instore the stylist immediately enters the customer's personal style profile 2 into the Retailer's Customer Database 3. If the member has had an analysis done elsewhere and has their personal style profile online—or on a USB Key or Member Card 14—and would like their personal style profile entered into the instore Retail Customer Database, it is done through the DCAPP 8, via the Instore Computer Terminal 17, either from within the store premises, or online via the USB Key and/or their own Consumer's Computer 13.

For a consumer using their personal style profile with a web-based retailer, the consumer uses personal style profile (in their online personal style profile, or on their USB Key and/or the Consumer's Computer 13) to enter the DCAPP 8 via the retailer's website 17, and gain access to the Customer Database 3.

The retailer's website 17 is connected to the Retailer's Customer Database 3, allowing new members' Style Profiles to be downloaded through the website from the Independent Styling Studio, or from a Stylist 19 if an independent stylist has been contracted by the retailer to conduct their personal style profile analysis. The retailer can offer CLASS members incentives to download their personal style profile onto their Customer Database 3.

Each member's personal style profile is accessible to the member online or through a computer terminal in communication with the Retailer's Customer Database 3 at the retail store, enabling the member to use it when purchasing, and can be used as back-up in case the member loses their USB key or member card. The personal style profile remains there until the member wants to have it deleted or the retailer chooses to delete it.

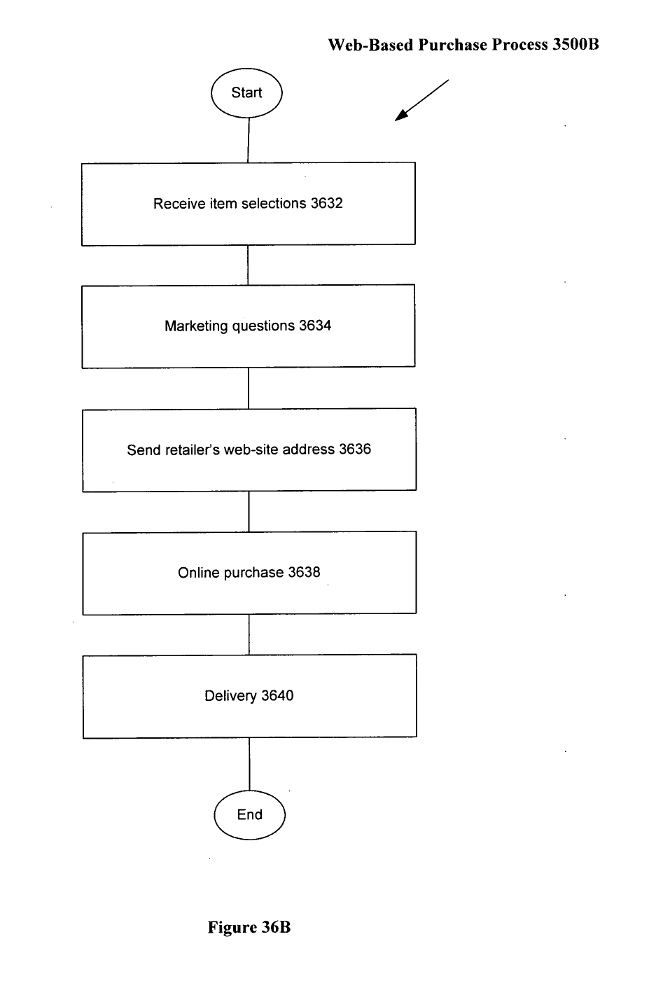

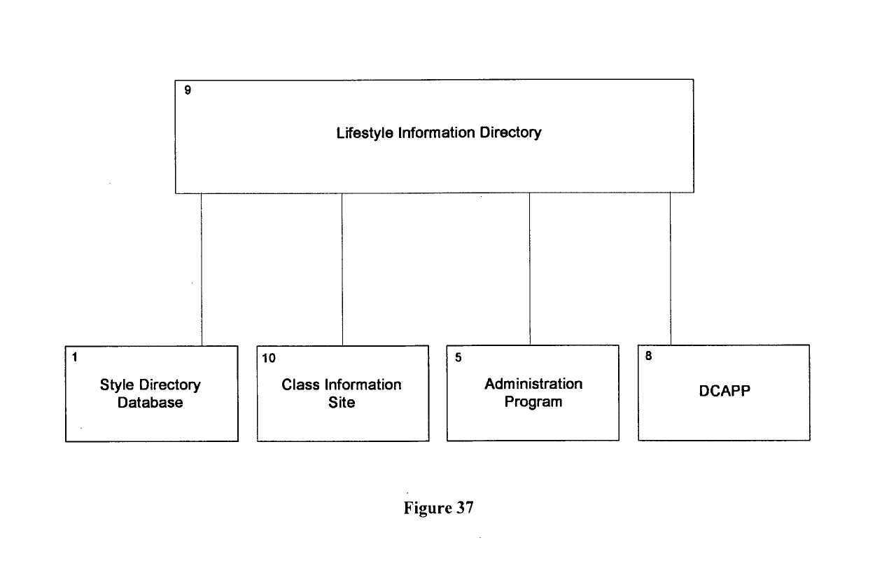

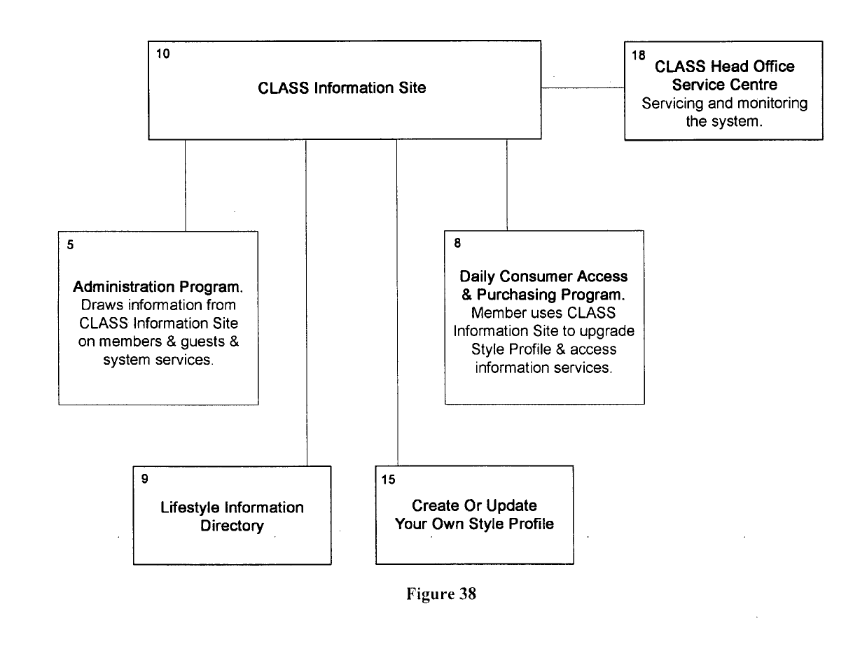

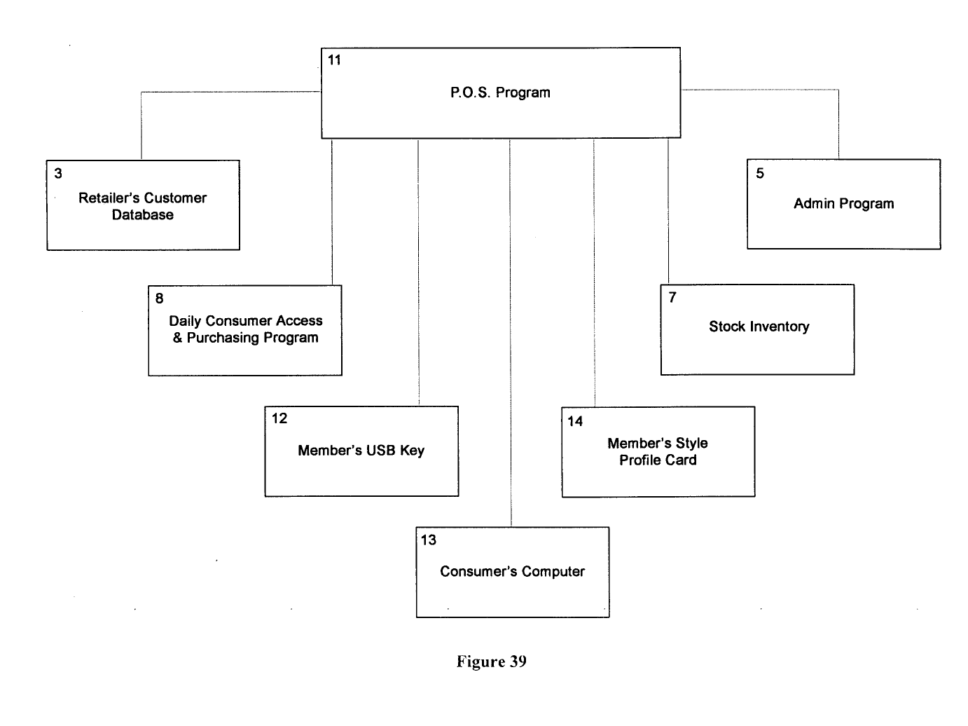

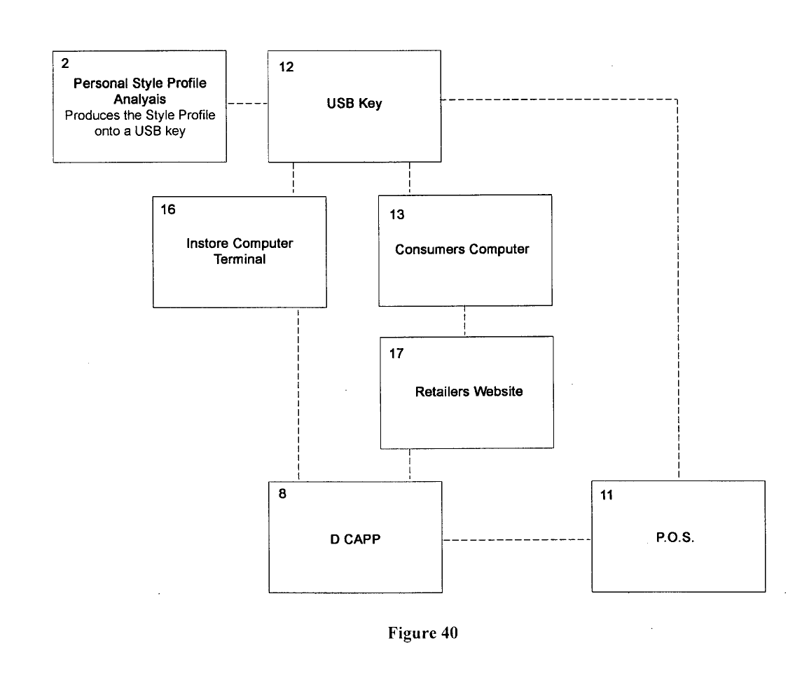

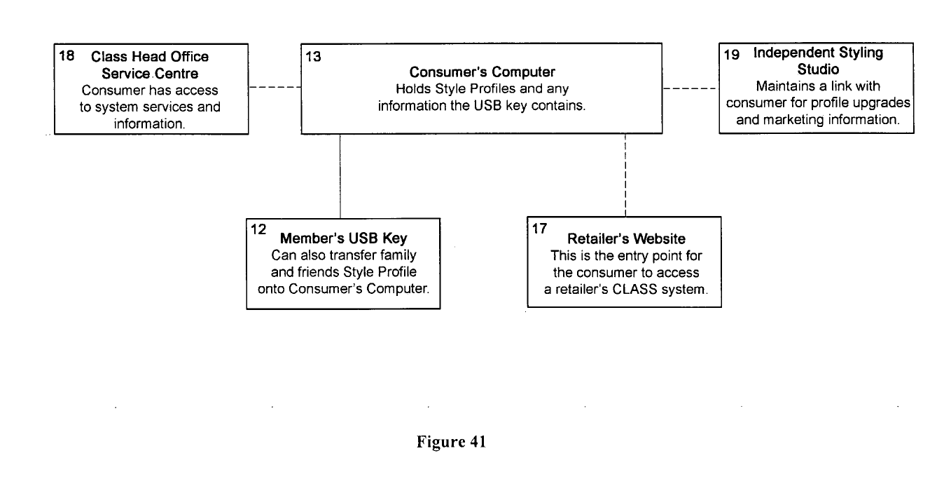

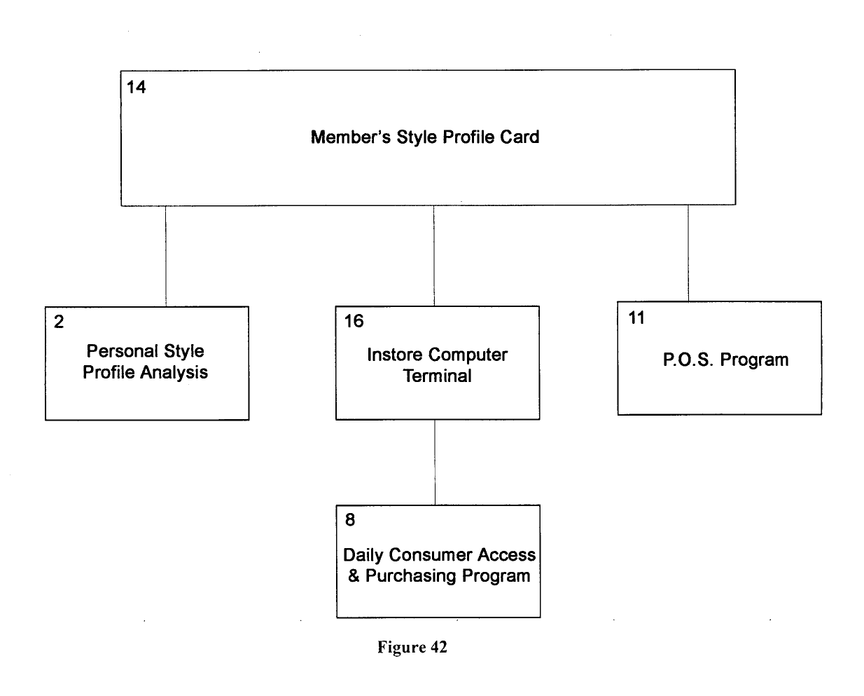

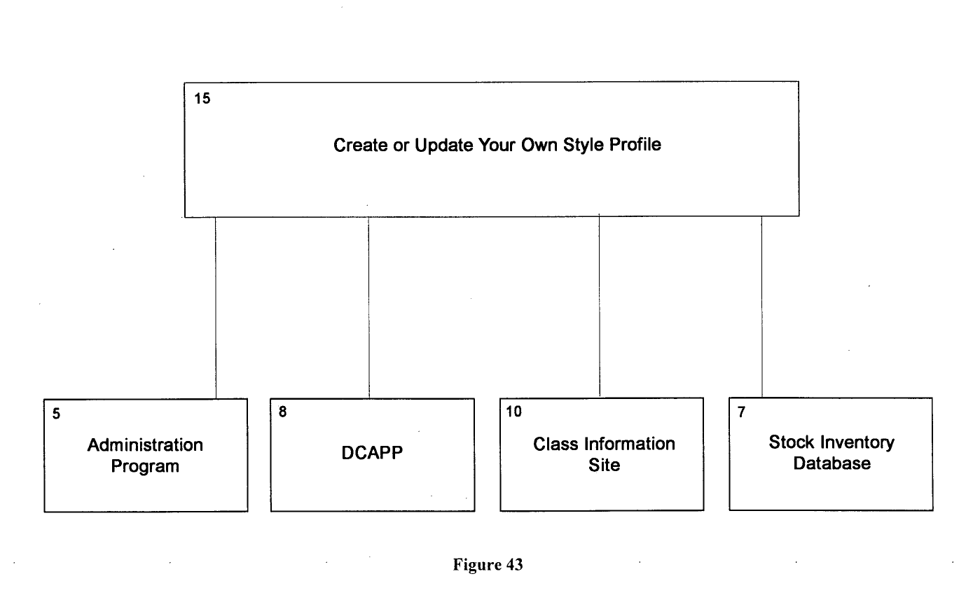

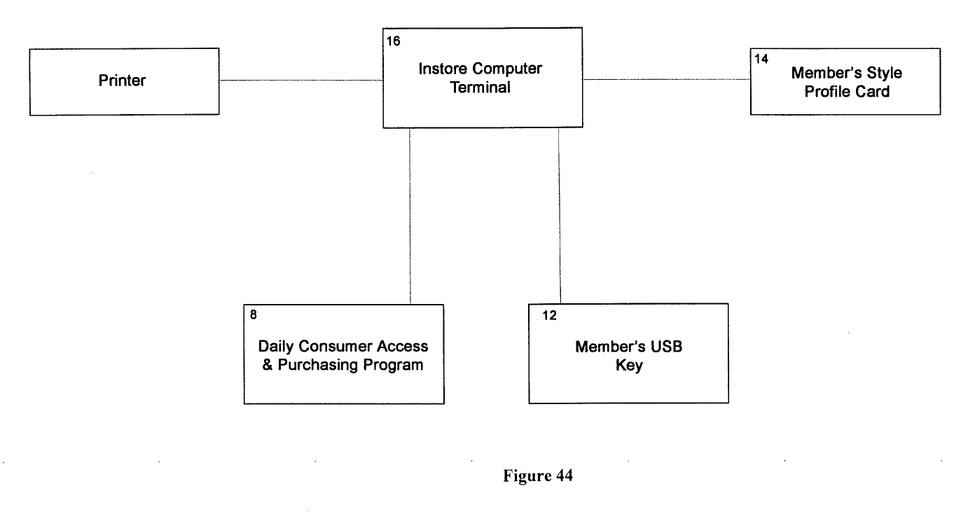

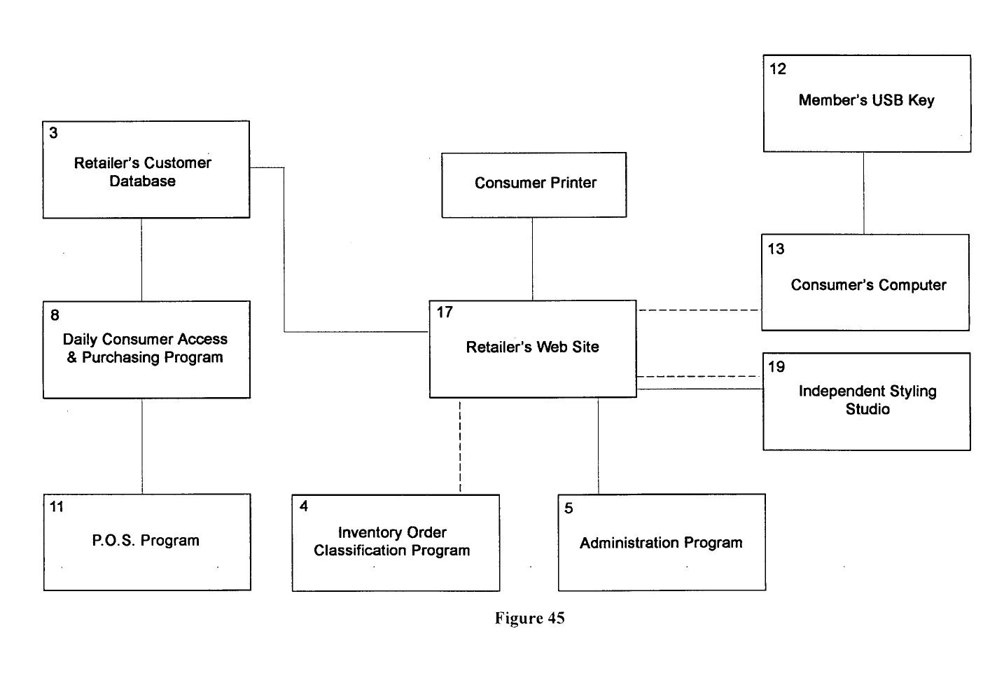

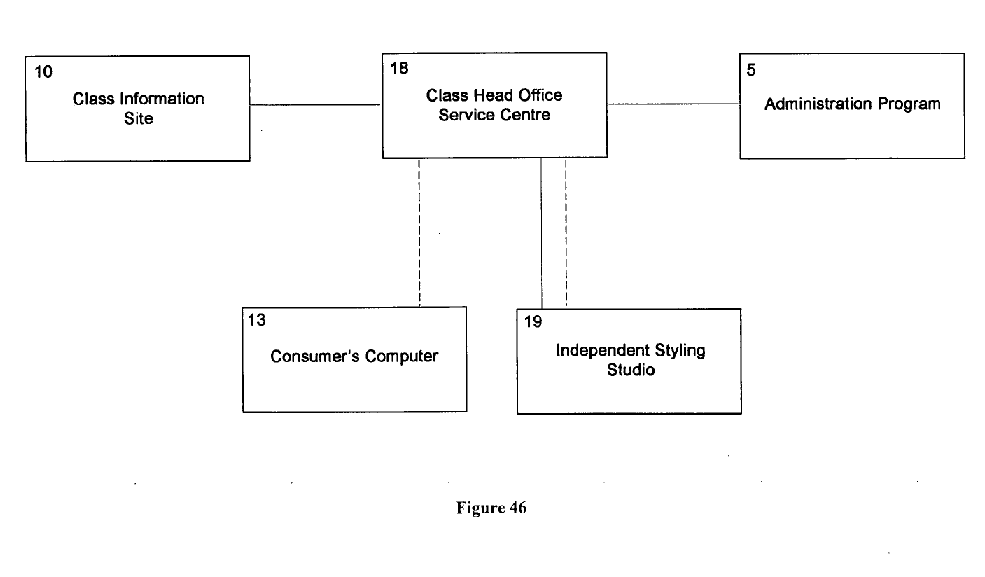

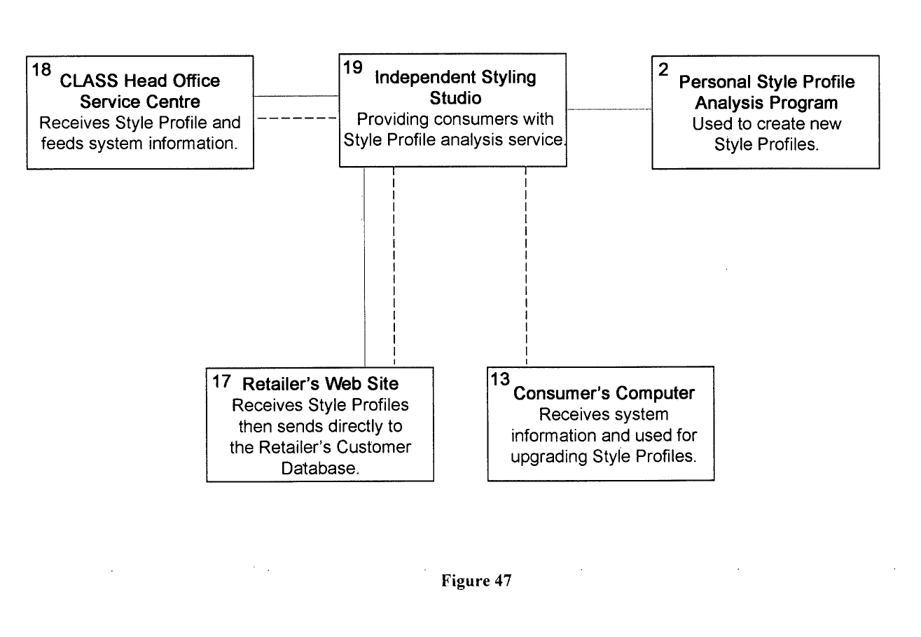

The Retailer's Customer Database 3 is used by the DCAPP 8 when a member enters their identification details. The DCAPP 8 generates, or ‘draws’, the member's personal style profile from the Retailer's Customer Database 3, holds it within the DCAPP 8 while it uses the personal characteristics from within the personal style profile for what ever purpose the member requires, in step 815 of the DCAPP 8 (see FIG. 36). If the consumer chooses to access the Life Style Information Directory 9 the Class Information Site 10 and/or chooses to answer any personal questions or leave any information in the DCAPP 8 the information is added to the member's personal style profile, held open by the DCAPP 8.

A member's personal style profile from the Customer Database has the option to have a personal style profile of a third party (e.g., a family member or friend) attached, enabling the member access to these Style Profiles whenever they like. A third party's personal style profile can only be attached to another member's personal style profile record, or “card” by the third party.

The Retailer's Customer Database 3 in communication with the retail P.O.S. Program 11, either instore or on a website, ensuring that each sale a member is recorded on the member's purchase history, the record of the sale including a photo of each item purchased. In order to save space on the computer the item information, including the photo of the purchased item, may be deleted after a certain period of time (e.g., five years). The Retailer's Customer Database 3 is also in communication with the Administration Program 5 where a customer's personal style profile, purchase history, and other Life Style information is accessible by the staff of the retail store or Web Site company, for marketing and research purposes.

### Inventory Order Classification Program (IOCP) 4

The Inventory Order Classification Program (IOCP) 4 is configured to categorize each item of clothing or accessory as it is entered into the inventory. The features of this program can be used independently, i.e., to enable buyers to use the program in a mobile operation if they need to be out on site at a supplier, possibly in another county. An order, identifying one or more Items, may be downloaded from the IOCP 4 over the Internet to the retailer's website 17. If required urgently by the retailer, the order may be downloaded when a mobile computer is connected to the system once the buyer is back in the office. It may be linked permanently depending on the application.

Buyers of vertical retail operations or large single brand chain stores may not need to categorize the styles ordered (i.e., assign item values to the item's database record) if a stylist, a designer or qualified staff has already categorized the items before the final sampling collection is confirmed. As stock is entered into a store's inventory, the Items are categorised (i.e., have item values assigned) using the IOCP 4. A confirmatory check may be performed by Administration once the order has been downloaded to the Administration Program 5. If an Item has already been categorized by a supplier, when a store places an order the Item and its categorized features and necessary information (i.e., the item record) is automatically transferred from the supplier onto the buyers IOCP 4. The buyer fills out the rest of the order and the Administration Program 5 downloads it together with the photographs.

The IOCP 4 is made up of three “templates”, or forms or questionnaires, that provide the Central Item Classification Database 1d with Item Style inventory information and the

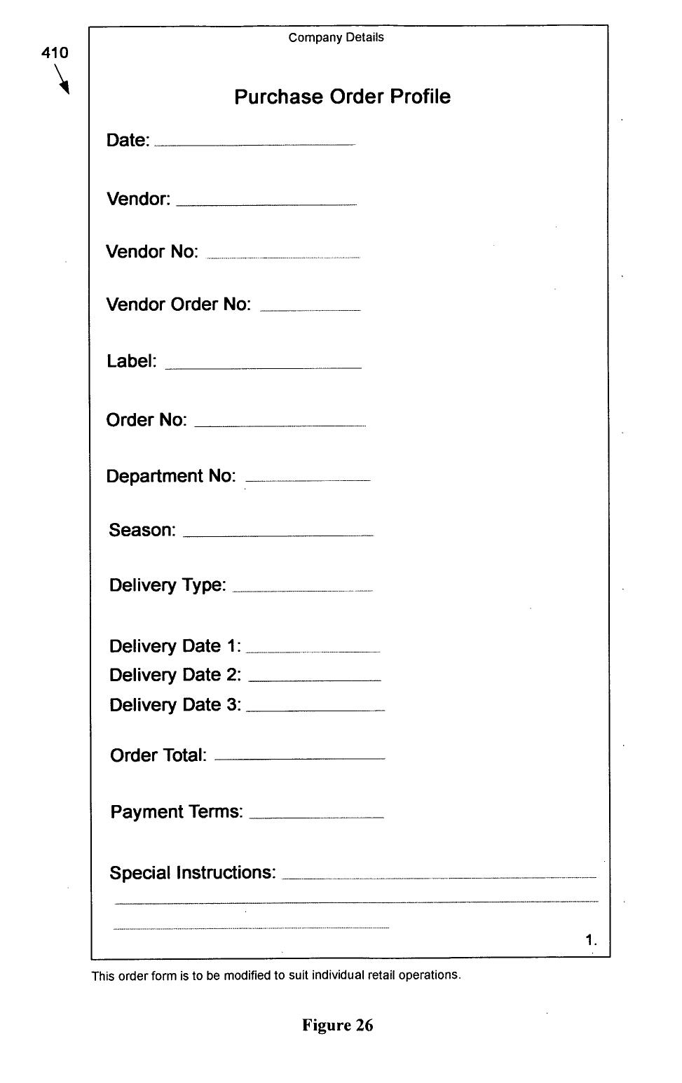

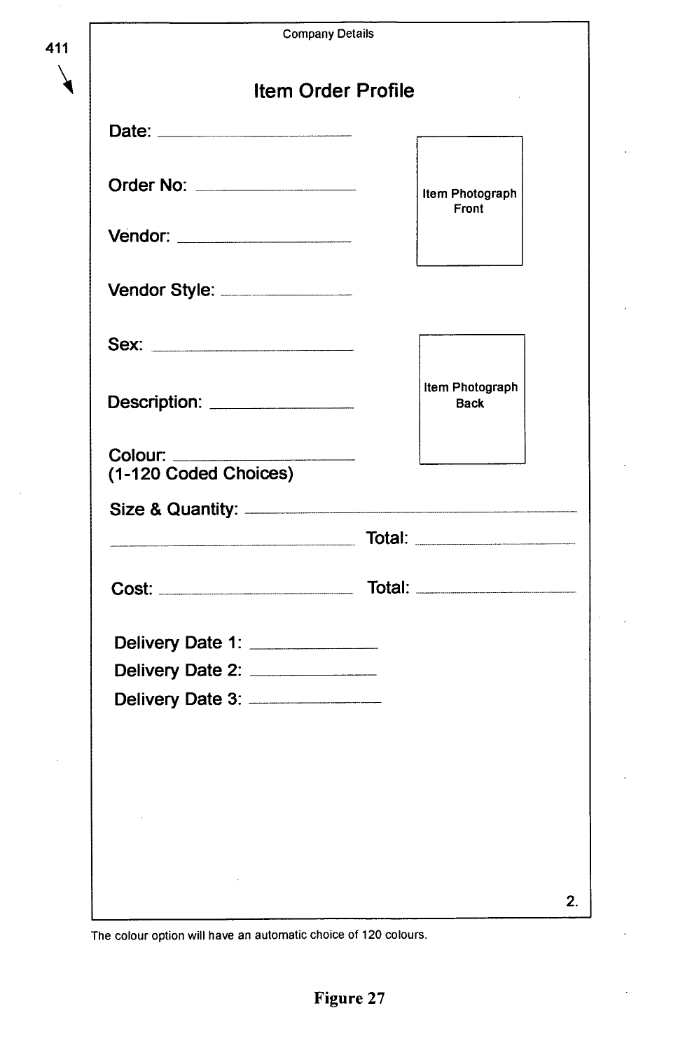

Administration Program 5 with the necessary supplier and Item Style information. As shown in FIG. 26, a first template is an Purchase Order Profile 410, which has basic order requirement information, including supplier details, delivery dates etc. As shown in FIG. 27, a second template is an Item Order Profile 411 which is a simple individual Item Style template including three item parameters, ‘Sex’, ‘Size’ and ‘Colour’, together with a photograph of the front and back of a clothing garment, and additional photographs for each colour choice. The colour section within the Item Order Profile 411 automatically provides a choice of approximately 120 coded CLASS system colour classification categories for the buyer to categorize the Items. Each item colour may be photographed so the consumer can confirm the true colour of the item if purchasing online, thus not relying on the colour classification category which is for consumer and item colour classification and colour matching purposes. When completing the Item Order Profile 411, a photograph is generated for each item, thus the buyer can view the item straight away and determine whether the quality of the photograph is acceptable. Suppliers may provide multi brand stores with individual item photographs. The photographs of each garment that is used to sell off from the computer preferably conform to a common format, e.g., a photographic system of mannequins and models that can be manipulated by the computer. As shown in FIG. 28, a third template within the IOCP 4 is a Item Style Classification Profile 412 created to classify any ordered item that is to enter the retailer's inventory. The classification information for sections 1, 2, 7, 8, 9 and 10 in the Item Style Classification Profile corresponds to item parameters and values in the SDD 1. Each item parameter has a

Classification Category Code/Number which corresponds to the same category code/number within the SDD 1 and the Inventory Databases. The classification information for sections 3, 4, 5 and 6 in the Item Style Classification Profile 412 document correspond to the SDD 1: these are static categories within the IOCP 4. Parameters ‘Design Preference’ and ‘Item Weight’ have a code attached because they are categories the consumer chooses from; parameters ‘Style Preference’ and ‘Generation’ are automatically taken from the consumer's personal style profile.

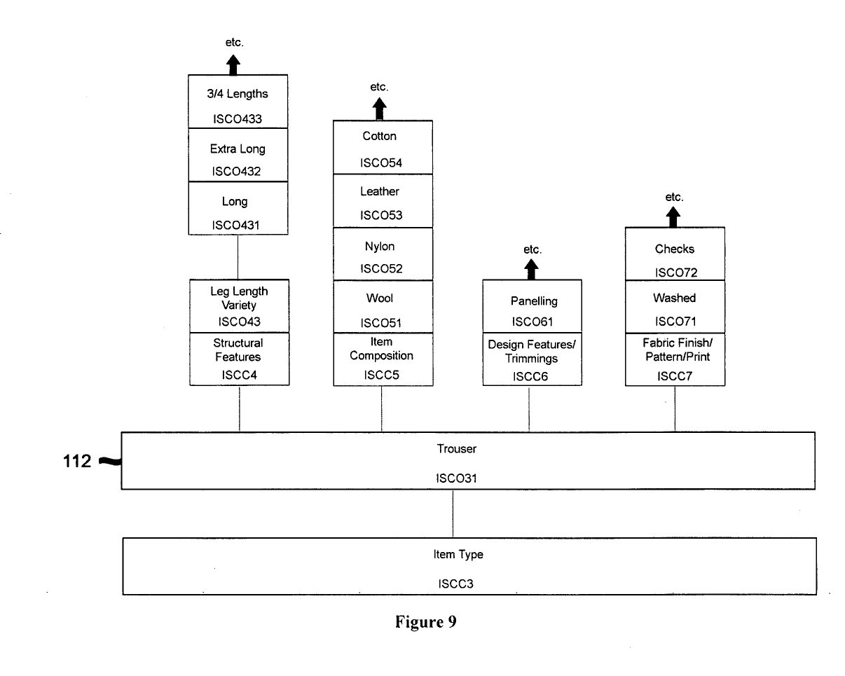

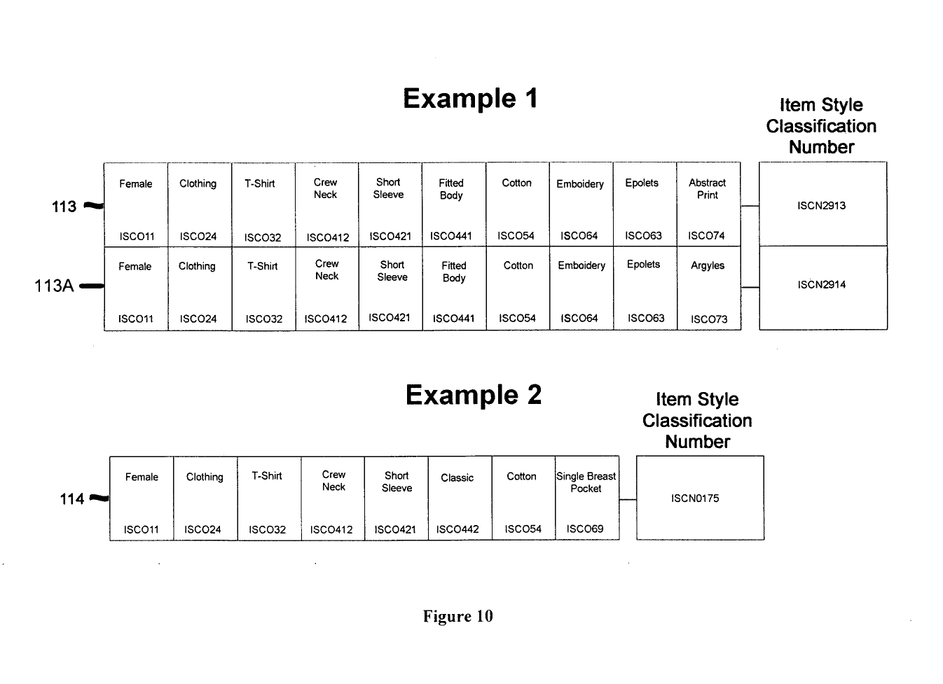

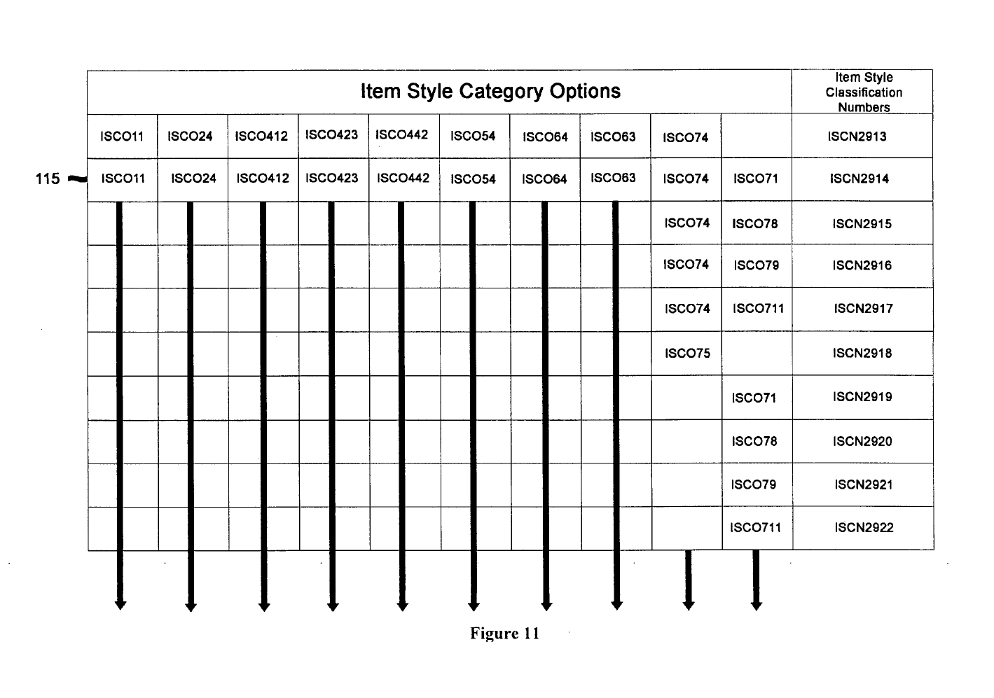

Starting with ‘Sex’, information from the Item Style Classification Profile 412 is used to generate item style Classification Category Codes/Numbers within the SDD 1 (see 111 and 112 in FIGS. 8 and 9) and for the Item Style Classification Number (see 113 and 114 in FIG. 10). The generated Item Style Classification Number is allocated to the new inventory item and sent back to the Administration Program 5 for addition to the Item Style Classification Profile template 412. It is possible for the CLASS system 1000 to give two very similar garments the same Item Style Classification Number which do not pose an identification problem for the system, given the supplier's individual style number is included on the template 411.

The Item Style information for the Inventory Databases may be sent before the stock has arrived if a retailer chooses too, allowing the consumer to pre-order stock. The IOCP templates 410, 411 and 412 in FIGS. 26, 27 and 28 may include an illustration for each item value to assist the buyer to select the correct value for each item parameter.

Administration Program (AP) 5

The Administration Program 5 monitors and controls the CLASS system 1000 from the CLASS Headquarters. A direct link from the Administration Program 5 to the SDD 1 allows administration staff to monitor the parameters (“classification categories”) and make requests to the CLASS head office and service programming team to implement changes or additions to the available item parameters, item values, personal parameters and personal values due to new fabric, design features, changing fashion trends, user specific requirements, etc. The Administration Program 5 accesses the SDD 1 to supply Item Numbers for items being added to a retailer's inventory on request from the retailer and/or consumer.

The Retailer's Customer Database 3 can be linked to the Administration Program 5 and supplies the retailer with both the online and instore customer database details, including purchasing history, buying and lifestyle habits and the customers' contact details for marketing purposes.

The Administration Program 5 receives notice when a consumer's personal style profile has been downloaded through the retailer's website 17 to the Retailer's Customer Database 3 from an independent stylist who has been contracted by the retailer to carry out a personal style profile analysis on their customers or new customers.

The link from the Administration Program 5 to the Inventory Order Classification Program 4 is for the buyer(s) to send inventory orders from their internal computer. The retail buyers can send (e.g., via email) a completed inventory order from the Inventory Order Classification Program 4 to the retailer's website 17 if they are in an external buying environment, possibly in another country, and the Administration Program 5 then receives it and processes it to the Purchase Order Database 6. Once an inventory order has been received by the Administration Program 5, the Administration Program 5 checks it, takes what information it requires then sends the completed information including ‘Sex’ from the questionnaire 411 (as shown in FIG. 27) and ‘Item Field’, ‘Item Type’, Item Composition’, Structural Features’, ‘Design Features/Trimmings’, and ‘Fabric Finish/Pattern/Print’ from the questionnaire 412 (as shown in FIG. 28) to the SDD 1.

When a new inventory item has been allocated an Item Style Classification Number by the IOCP 4, and the initial photographs confirmed as acceptable, the Administration Program 5 sends the order information template to the holding program as item data within the Central Item Classification Database 1d, the Purchase Order Database 6 and may also send it to the Inventory Databases as an Inventory Pre-Order. The orders and pre-orders are stored in the Purchase Order Database 6 until the stock is received from the supplier. Once the stock is checked off and the correctly formatted photographs taken, the purchase order is transferred out of the Purchase Order Database, into the retailer's Inventory Databases 1h,1l. When the stock arrives for an order that had been sent to the Inventory Database as an Inventory Pre-Order, the order is still transferred out of the Purchase Order Database 6 and then sent to the Inventory Database.

The Central Item Classification Database 1d supplies the Administration Program 5 with all inventory monitoring and control information, including the pre-order sales generated before the stock arrives and all daily and after hours on-line and in-store sales information.

The Administration Program 5 accesses all information generated by the DCAPP 8 by customers and consumers who buy or browse. There are options of questionnaires that the retailer can include to monitor problems and successes, and add in marketing or communications material. Administration Program 5 monitors consumers browsing through a direct link to the Life Style Information Directory 9. The Administration Program 5 provides retail administration with consumer information and gives the retailer another marketing opportunity via the Class Information Site 10. The Administration Program 5 has direct access to the P.O.S. Program 11, primarily for accounting and system administration purposes. The Administration Program 5 monitors the Create Or Update Your Own Personal Style Profile 15 program for new customers, i.e., people who try the system before becoming a member, in order to send and display advertising and communication messages to the new customer, e.g., to join the CLASS system 1000 through their retail store or on-line service.

The Administration Program 5 uses the retailer's website 17 to receive inventory orders from the inventory Order Classification Program 4 that the buyer has placed with suppliers on location. The Administration program 5 provides a communications link from the CLASS Head Office & Service Centre 18 to each of its retail customers, used for a number of technical and marketing purposes.

Marketing Processes

The marketing staff of the retailer are able to access the personal details of their Customer Database 3 and other consumers who have used their CLASS system 1000, targeting different types of marketing strategies to suit the personal requirements of them, including new seasons stock, sale stock or one-off promotions. The Administration Program 5 can target appropriate marketing information for a particular item of clothing, by drawing it out of the Central Item Classification Database 1d. The Administration Program identifies in the Retailer's Customer Database 3 which member's personal characteristics from within the member's personal style profile match the item. Once this information is ready the Administration Program 5 uses the retailer's website 17 to launch the marketing process. This type of target marketing can be done for particular styles, colours, individual items, particular brands or total departments of new or sale stock.

A particular clothing Brand promotion in a multi brand store can be performed by drawing the stock of the targeted brand out of the Central Item Classification Database 1d and the Style Profiles out of the Retailer's Customer Database 3 of members who have purchased this brand before, or members who have identified this brand as desirable through using the CLASS system 1000 previously, or from members who have identified this brand as desirable through the retailer's own research. Other members may also be targeted because their personal style profile from within the Retailer's Customer Database 3 matches the branded stock based on the export rules 2002. The Administration Program 5 identifies which members' physical characteristics match the particular stock on hand and target the appropriate marketing strategy for that brand.

Another type of promotion is to target the members' needs by identifying all stock that suits the personal characteristics of a consumer by first drawing out the particular personal style profile of a customer from the Retailer's Customer Database 3, drawing out all items that match the member from the Style Directory 1 (based on the expert rules 2002), identify which of these items are in the stock inventory, and isolating the targeted inventory. This can be used for new stock or an overall promotion. The consumer can be emailed a particular promotion of photographs or be sent a flyer by mail, inviting them to come into the store and try the stock on, or encouraged to buy online.

Purchase Order Database (POD) 6

The Purchase Order Database 6 is a database that holds pending orders before the orders are delivered in the CLASS Central Hub for each retailer. As shown in FIG. 1B, in the CLASS Central Hub, the purchase order database 6 includes the purchase order databases 1i,1m of the retailers.

The Administration Program 5 downloads the processed orders from the Inventory Order Classification Program 4, accesses the SDD 1, locates then allocates an Item Style Classification Number to each item from the order, then sends it to the Purchase Order Database 6. The template used by the Purchase Order Database is similar to the Central

Item Classification Database 1d and not the Inventory Order Classification Program because much of the information off the IOCP 4 is for Administration and not necessary for the Central Item Classification Database 1d. The Item Style Classification Numbers are allocated to the items before entering the Purchase Order Database because if a problem arises there is time to fix it before the stock is delivered. The orders wait in the Purchase Order Database 6 until the physical stock arrives into the retail store or warehouse. The orders can also be sent to the Central Item Classification Database 1d by the Administration Program 5 before receiving the physical stock, as long as an Item Style Classification Number has been allocated, this allows the customers to pre-order stock. Once the physical stock arrives, each item is checked off against the order, including checking the photo of each item that was taken at the point of order: this verifies that the item has been manufactured and delivered correctly. Once the stock has been checked off against the purchase order held in the Purchase Order Database 6 and accepted by the retail store as correct, the Administration Program 5 draw back the purchase order, any adjustments or changes required to be made to the purchase order are made by administration staff—such as short delivery etc.—and then the Administration Program 5 enters the purchase order into the Central Item Classification Database 1d.

Central Item Classification Database 1d

The Central Item Classification Database 1d is a database that holds all stock of the retail store or online shopping service. It is designed to accept only stock that has been classified through the Inventory Order Classification Program 4, can be tailored made to suit any retailer's existing format and includes photographs and relevant information of each item and its classified categories. Once the retailer has ordered stock and completed the necessary order format from the IOCP 4 there is an option through the Administration Program 5 to send the purchase orders to the Central Item Classification Database 1d before the inventory has arrived.

Each Item Style already has an item record (i.e., the item has “been classified”), allowing the retailer to display to their customers, through the DCAPP 8, what stock is coming in, the relevant Item Style information, what inventory matches their personal style profile and Item requirement, giving the customers a chance to pre-order and pay. Details for pre-ordering are in the bottom section of the Stock Inventory Database template 710 and include Item details such as delivery dates, photographs, quantities, and customer ordering details such as payment and delivery address.

When the physical stock arrives and is checked off against the purchase order that is waiting in the Purchase Order Database 6 and, or in the Central Item Classification Database 1d as an Inventory Pre-Order, the information that the Central Item Classification Database 1d requires off the purchase order (including the Item Style Classification Number), are drawn from the POD 6 by the Administration Program 5, together with the original photographs, and sent to the Central Item Classification Database 1d. If the photographs that were taken at the time the buyer was buying are not satisfactory, a new photograph is taken.

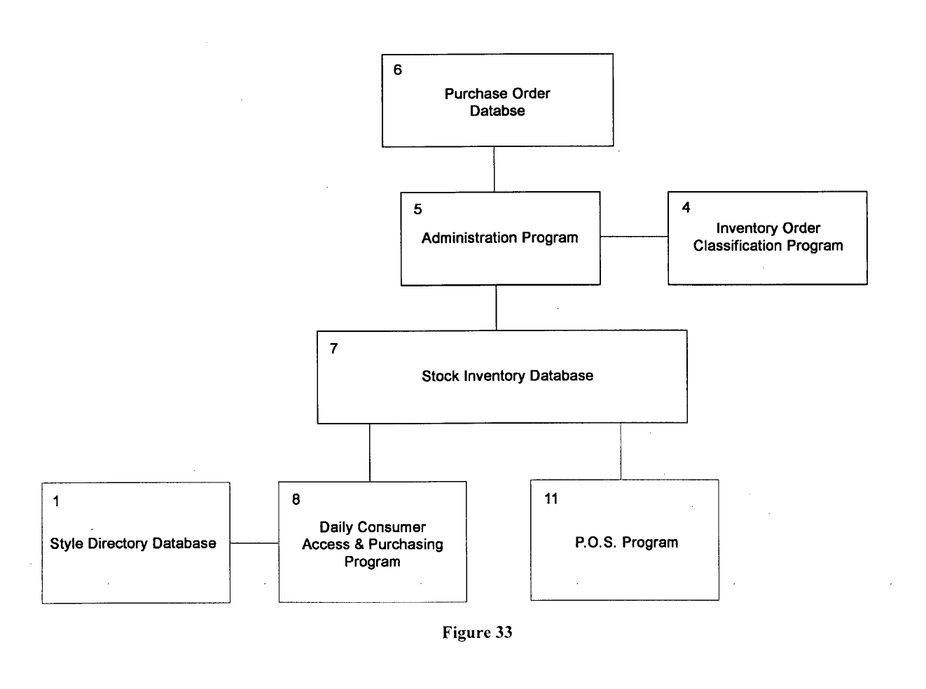

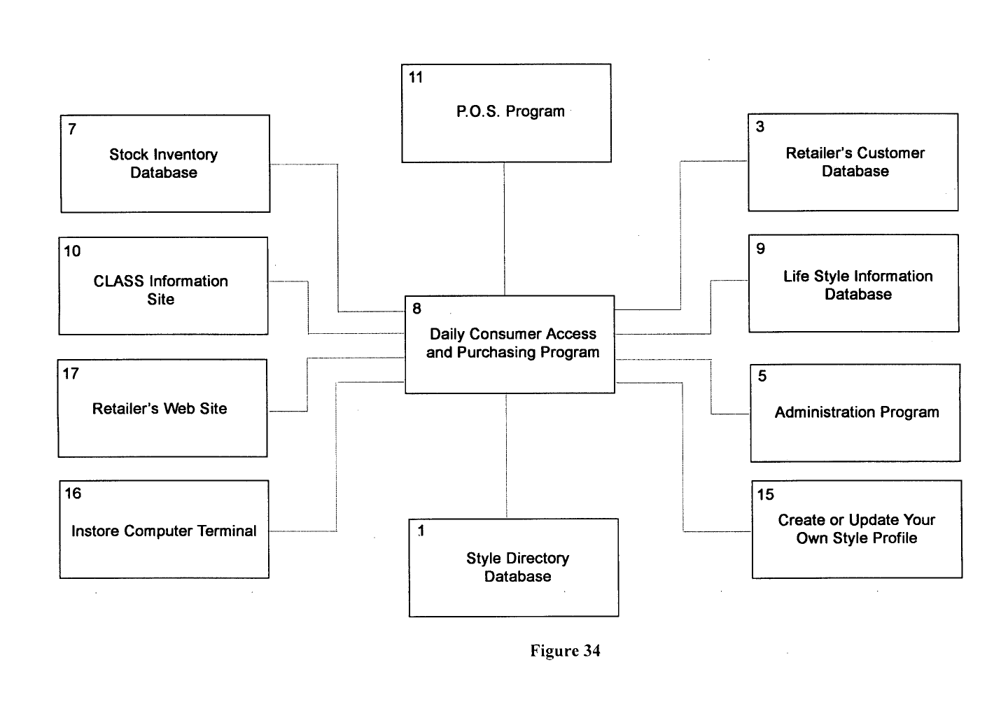

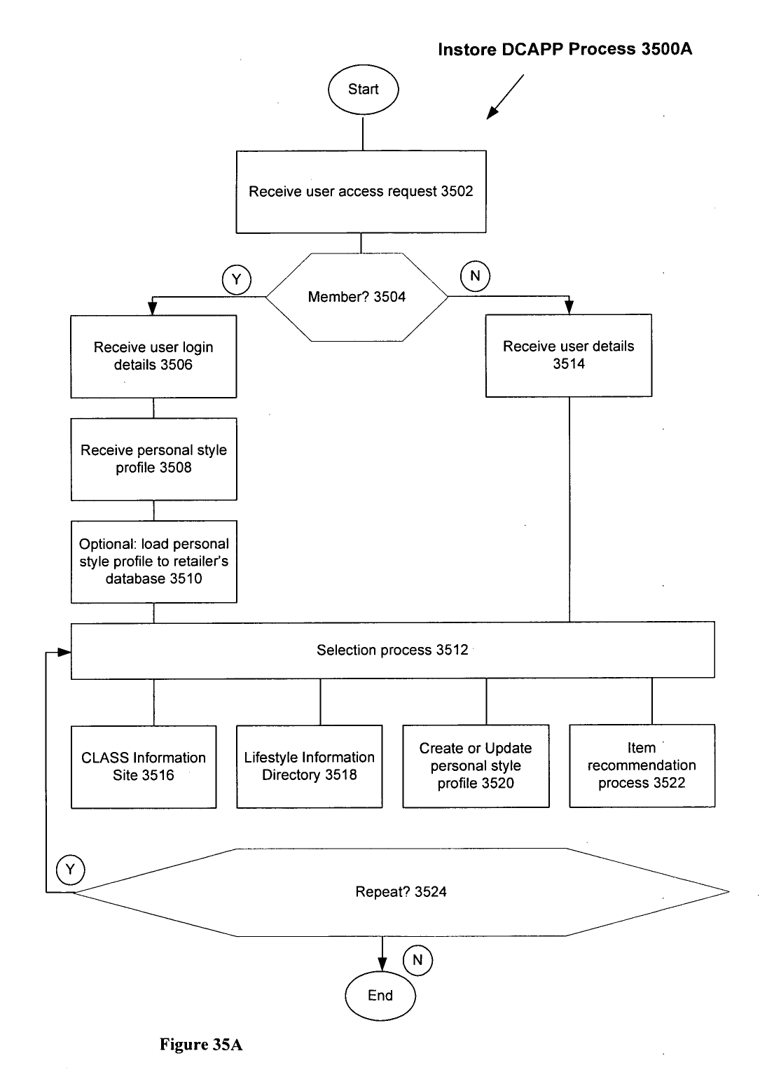

As shown in FIG. 33, a database information sheet, for use with the Central Item Classification Database 1d, typically includes both inventory information (e.g., pricing and quantities) and classification information (e.g., Matching Categories).

Each item that is entered into the Central Item Classification Database 1d includes the normal supplier's item details; however in the CLASS system 1000 each item that is entered into the Central Item Classification Database 1d is also automatically allocated a CLASS Item Style Classification Number. This classification number is included within the barcode of the item, so it can be checked at the point of purchase.

The Central Item Classification Database 1d matches a consumer's stock request with its inventory, isolating items through Item Field, Item Type, Design Preference and Item Weight, classification categories that the consumer has chosen while in the DCAPP 8. The DCAPP 8 accesses the Central Item Classification Database 1d to locate particular stock for which the consumer is searching. Using the personal style profile details of the consumer and the item style details the consumer has requested (in the DCAPP 8), the Central Item Classification Database 1d, and/or the Inventory Databases 1h,1l of the retailers, locates all relevant items by their Item Style Classification Number and sends them to the DCAPP 8 where they are cross-referenced with Item Style Classification Numbers that the DCAPP 8 has drawn from the SDD 1. The remaining items are transmitted to the DCAPP 8 where they are displayed by photograph for the consumer to view.

Once an item has been purchased it is taken off the inventory through the P.O.S. 11.

The Central Item Classification Database 1d is also be linked to an ordering system through the DCAPP 8 that allows the member to order garments that are out of stock but are on a stock service program or even view and order indented fashion stock. Once the member has entered an order, the inventory database sends the order to the administration program 5 for processing.

Daily Consumer Access and Purchasing Program (DCAPP) 8

The consumer access options to the DCAPP 8 include full access for members and restricted access for non-members. Full access applies when members use their personal style profile in conjunction with the system, while non-members can use a DIY personal style profile with limited matching options. Both members and non-members can browse the system for information.

The DCAPP 8 may be in the form of an Instore DCAPP 8a or a Web-Based DCAPP 8b. The steps executed by these two DCAPPs 8a,8b are generally equivalent for steps occurring after steps access has been established and before sale, delivery and pick-up.

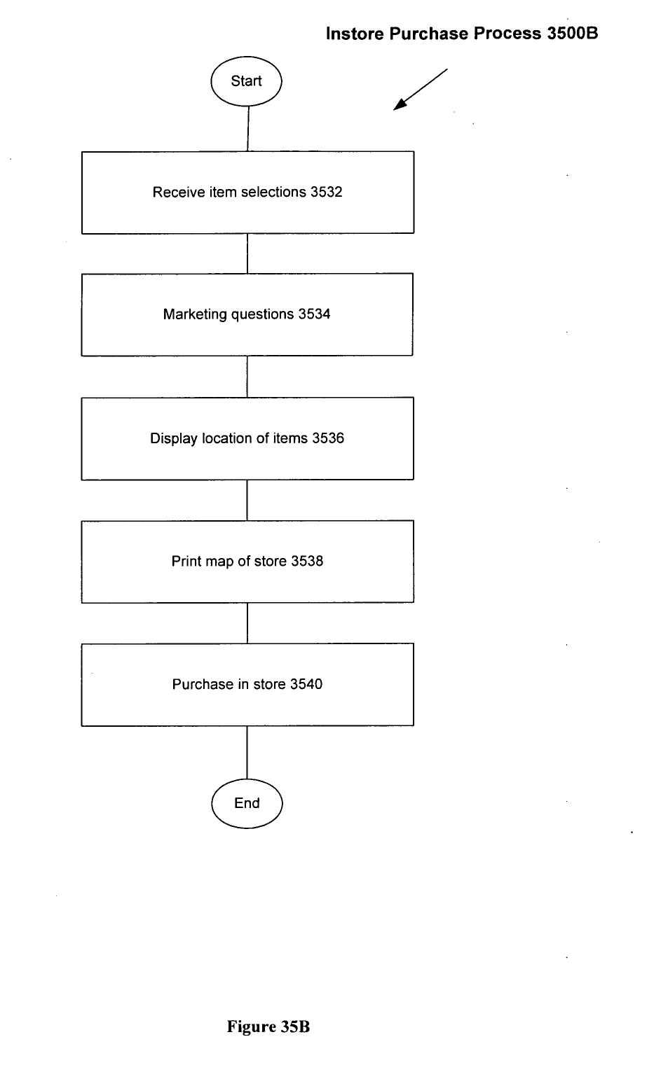

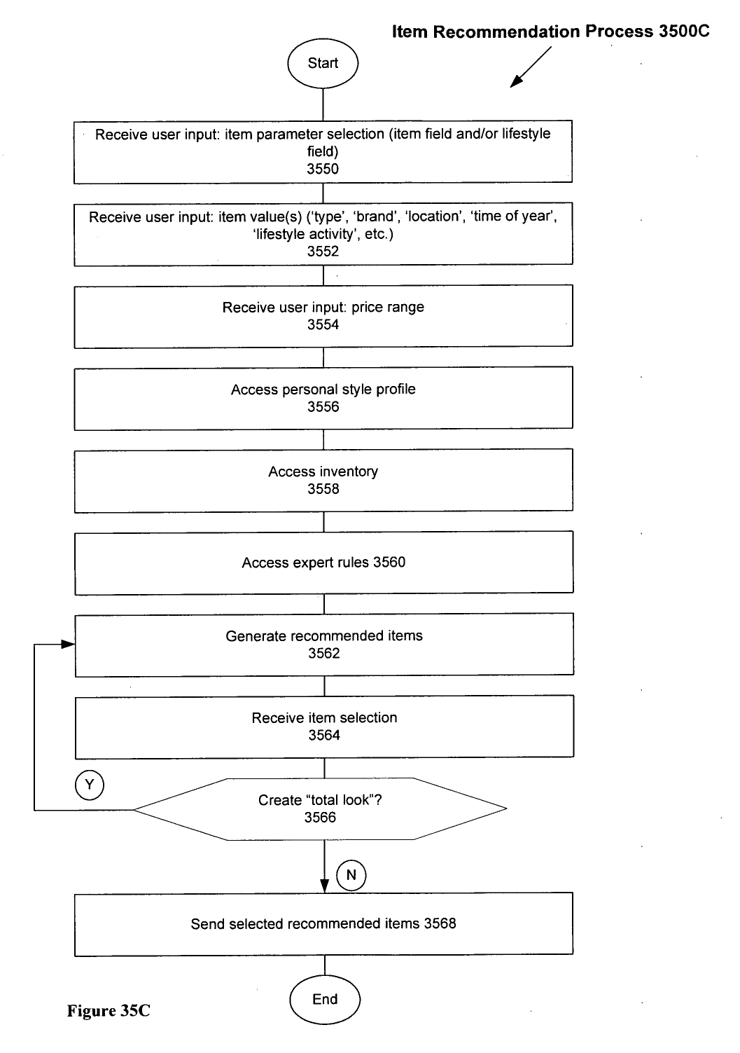

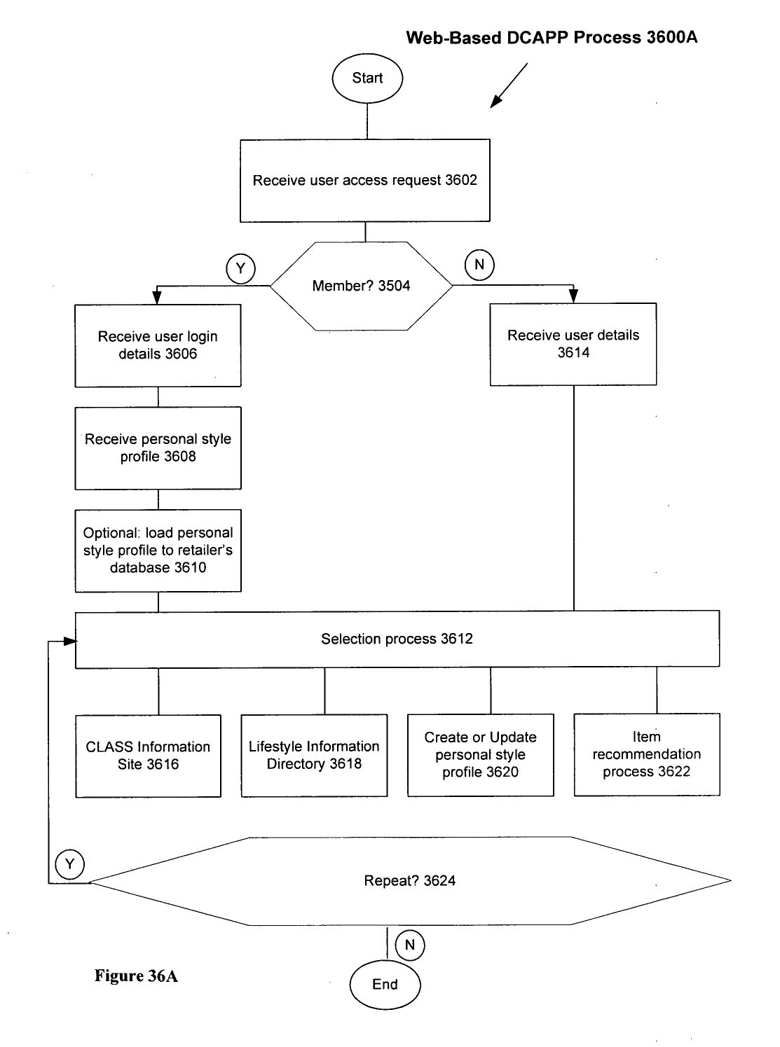

As shown in FIG. 35A, an instore DCAPP process 3500A commences with the DCAPP 8 receiving a user access request (step 3502). The user accesses the DCAPP 8 in the CLASS system 1000 using for example an instore computer terminal in a store of a retailer. The user may be a member or a non-member, as tested in step 3504. If the user is a member, the DCAPP 8 receives user login details (step 3506) and receives or accesses the user's personal style profile (or a personal style profile of a third party) from the member, e.g., using the member's USB Key, or the member's Style Profile Card, or the member's personal style profile available on a networked server (i.e., the online personal style profile, accessed using the user login details) or from data input by the user (step 3508). The DCAPP 8 may optionally load the personal style profile of the member to the retailer's database, if the user wishes (step 3510). Once the user is logged in and the DCAPP 8 has loaded the one or more personal style profiles, the instore DCAPP process 3500A enters a selection process (step 3512) in which the user selects how they wish to proceed. If the user is not a member (tested in step 3504) the DCAPP 8 receives the user details (step 3514), which may include a temporary personal style profile and other user selections (step 3514), after which the instore DCAPP process 3500A enters the selection process (step 3512).

In the selection process of step 3512, the user selects one of the following four options. (1) the DCAPP 8 providing the user access to the CLASS information site (step 5316); (2) the DCAPP 8 providing access for the user to the lifestyle information directory (step 3518); (3) the DCAPP 8 creating or updating the personal style profile, based on user input (step 3520); or (4) the DCAPP 8 performing an item recommendation process 3500C (step 3522). Following the selected process, the DCAPP 8 allows the user to repeat the selection process of step 3512, or to exit the instore DCAPP process 3500A (step 3524).

In the described embodiment, the instore DCAPP process 3500A requires the member to enter their USB Key or the member's personal style profile card 14 into the Instore Computer Terminal 16, or to access their online personal style profile. The member proceeds directly into the DCAPP 8, answers ‘yes’ to being a member, provides their name and a security code number for authentication purposes and then their personal style profile is retrieved from their personal style profile through the Instore Computer Terminal 16. The member may chose to retrieve another person's personal style profile that they have on their USB Key or Computer. A member using the instore DCAPP 8a who does not have their USB Key, or their personal style profile card 14, enters the Instore Computer Terminal 16, and enters their name and security code number. Once verified, the member's personal style profile is retrieved from the Retailer's Customer Database 3 (i.e., the online personal style profile). There is a process within the Retailer's Customer Database that allows the member to retrieve another person's personal style profile if the system acknowledges that the member had given previous consent. With the DCAPP 8 now holding the member's personal style profile the member decides what service they wish to use through the CLASS system 1000. A non-member who uses the system through the instore DCAPP 8a enters via the Instore Computer Terminal 16. They answer ‘no’ to the membership request in step 3504. They need to give their name and some personal details; once these details are given they have a choice as to which CLASS service they would like to use.

As shown in FIG. 36A, a web-based DCAPP process 3600A commences with the DCAPP 8 receiving a user access request (step 3602) via an Internet connection, e.g., via a retailer website. The remaining steps of the process are generally the same as those of the instore DCAPP process 3500A, described above with reference to FIG. 35A, except for a web-based purchase process 3600B described below with reference to FIG. 36B.

In the described embodiment, a member using the web-based DCAPP process 3600A has their personal style profile on a USB Key connected to the Consumer's Computer 13, or their personal style profile on the Consumer Computer 13, or the online personal style profile accessible by the Consumer Computer 13. The member logs onto the retailer's website 17 from the Consumer's Computer 13 and proceeds directly to the DCAPP 8b process, as shown in FIG. 36. The member is asked whether they are a member of the CLASS system 1000; if so (answering ‘yes’), they enter their name and security code number. Once their identification is verified, the DCAPP 8b retrieves their personal style profile from either their USB Key or the Consumer's Computer 13 through the retailer's website 17. If the member does not have their personal style profile available through the Consumer's Computer 13, the DCAPP 8 retrieves it from the Retailer's Customer Database 3. There as a process within the Retailer's Customer Database 3 that allows the member to retrieve another person's personal style profile if the member had given previous consent. With the DCAPP 8b holding the member's personal style profile, the member proceeds to decide what service they wish to use through the CLASS system 1000. A non-member who uses the system through the web-based DCAPP 8b uses the Consumer's Computer 13 to enter through the retailer's website 17. They answer ‘no’ to the membership request in step 3504. They need to give their name and some personal details; once these details are given they have a choice as to which CLASS service they would like to use.

In the described embodiment, the member has four choices in step 3512, and the non-member has three choices: (i) option 1 is accessing the Life Style Information Directory 9 for information and direction on personal care clothing and fashion trends; (ii) option 2 is to view the CLASS Information Site 10, providing help and marketing information on the CLASS system 1000 and retailer; (iii) option 3 is for the non-member to create their own Personal Style Profile and for the member to update their Style Profile: they proceed to Create or Update Your Own Personal Style Profile 15 and once completed re-enter the DCAPP 8 to use their new Style Profile; and (iv) option 4 is for the member only, the DCAPP 8 proceeding to recommended for items to purchase.

In the item recommendation process 3500C, the DCAPP 8 receives user input including an item parameter selection representing which item parameters will be used for selecting the one or more items (step 3550). The item parameter selection may relate to an item field (such as ‘Clothing’, ‘Footwear’, ‘Accessories’, ‘Makeup/Beauty’ and/or ‘Grooming’) and/or a Lifestyle field (e.g., ‘Career’, ‘Home’ and/or ‘Leisure’). Following the initial item parameter selection, the DCAPP 8 receives user input for one or more item values, such as ‘Type’, ‘Brand’, ‘Location’, ‘Time of Year’, ‘Lifestyle Activity’, etc. (step 3552). The DCAPP also receives a user input representing a price range for the desired items, or a price point such as ‘Low’, ‘Medium’ or ‘High” (step 3554). The DCAPP accesses the personal style profile and the personal data therein (step 3556), accesses the inventory data representing the inventory of the retailer (step 3558), and accesses the expert rules 2002 representing linkages between the features of an item and personal values in the personal style profile (Step 3560). The DCAPP 8 then generates recommended items based on the item data, the personal data and the expert rules (step 3562) and presents an indication of the recommended items to the user, e.g., a photograph of the one or more recommended items.

The recommended items may be secondary recommended items based on a secondary link between the item and one or more of the personal values. The DCAPP 8 receives an item selection from the user, e.g., by clicking on one of the photographs (step 3564). If the user wishes to select more than one item, they may decide to create a ‘total look’ which includes a plurality of associated items with connected styles (step 3566). If the user does not wish to create a total look, by selecting ‘no’ in step 3566, the DCAPP 8 then sends the selected recommended items to an ordering or a purchasing process (step 3568).

In the described embodiment, the user (a member, or a non-member using the daily DIY Style Profile) has eight options of how they would like to search for the items they want to purchase in step 3552: options 1 to 5 are based on Item Fields, namely ‘Clothing’, ‘Footwear’, ‘Accessories’, ‘Makeup/Beauty’, and ‘Grooming’; and options 6 to 8 are based on Lifestyle Fields, namely ‘Career’, ‘Home’, and ‘Leisure’. The DCAPP 8 has already started to use the member's personal style profile at this point, and therefore only produces Item and Lifestyle Fields that are relevant to the ‘Sex’ of the member. If the user chooses ‘Clothing’ (i.e., number 1), a screen with a list of Item Types that categorize all clothing for the member's Sex appear in alphabetical order: Jackets, Shirts, Trousers, etc. The same process is followed if any of the other search options are selected. The DCAPP 8 uses the SDD 1 to select item records with the appropriate code (‘Male’ or ‘Female’) in the ‘Sex’ parameter. The member then chooses one or more of the displayed Item Types they wish to search for, e.g., ‘Trousers’.

The DCAPP 8 selects item records matching the personal values from the personal style profile and the user selections based on the expert rules 2002, and generates a plurality of Item Style Classification Numbers to be sent to the Central Item Classification Database 1d.

The DCAPP 8 displays the various Design Preferences available, e.g., ‘Casual Trouser’, ‘Business Trouser’, etc from matching item records in the Central Item Classification Database 1d. There is a Price Point option that all retailers can include. The parameter ‘Item Season’ in the Item Style Classification Profile (e.g., addressed in number 6 of the example questionnaire 412 in FIG. 28) can be added to a retailer's DCAPP 8 as a further search choice for the consumer.

If the member chose the Clothing by Brand option (applicable for multi-brand stores) the available labels are displayed. The member chooses the label they would like to view and the DCAPP 8 draws all stock that matches their personal style profile from the Central Item Classification Database 1d to generate the recommended items and displays the items by photo and style number.

The recommended items (represented by their Item Style Classification Nos.) are the items that the retailer has in stock that correspond to the consumer's characteristics and the type of clothing they were searching for. The recommended items are displayed by photo, vendor style number and the Item Style Classification Number, for the consumer to choose.

The consumer is able to click on the photograph of each item to retrieve further information on the item such as: item composition, country of origin, how many are in stock, are any on order, when the item goes on sale, how long it has been on the shelf. Each retailer can choose how much information they would include in this further information. Once the member has chosen what styles they would like to buy, they proceed to the relevant purchase process for either a web-based application, or an instore application, where the add-on program presents them with a number of options. The add-on questions are simple, such as: would they like to view matching shirts if they chose trousers, or would they like to view shorts if the season is Summer and they chose a T-shirt. The DCAPP 8 locates the chosen items by style and colour from the SDD 1 and the Central Item Classification Database 1d.

As shown in FIG. 35B, an instore purchase process 3500B commences with receiving the item selections from the item recommendation process 3500C (step 3532), after which the DCAPP 8 delivers marketing questions to the user (step 3534). The DCAPP 8 displays the location of the items in the store (step 3536) and optionally prints a map of the store showing the locations of the items (step 3538). The instore purchase process 3500B completes following purchase of the items in the store (step 3540), which is recorded in the purchase history of the person and/or the user.

As shown in FIG. 36B, a web-based purchase process 3600B commences with the DCAPP 8 receiving item selections, as in the instore purchase process 3500B (step 3632), and optionally providing marketing questions for the user (step 3634). The DCAPP 8 then sends details of a retailer's web site—including the website address—to the user (step 3636) from which the user can then make an online purchase (3638). The web-based purchase process 3600B completes with delivery of the items to the user, e.g., by post or freight (step 3640).

When using the instore DCAPP 8, the member decides what items they would like to try on, the DCAPP 8 and the retailer gives them a choice of final marketing questions before a print out of the photographs of the chosen items are given and a detailed description of where in the store they can be found. After the member has tried on the clothing items and they have decided to purchase them, the member takes the items to the P.O.S. area where their Member Card or USB key is used to record the sale, apply a discount or whatever the individual retailer prefers to do when processing a sale. When using the web-based DCAPP 8, the member proceeds to the P.O.S. stage by following standard online purchasing procedures and the online personal style profile is used to record the sale, apply for a discount, etc.

Create Your Own Total Look

If the member chose the Create Your Own Total Look option, they start by choosing an Item Type. The DCAPP 8 uses the same process to access and retrieve the required Item records and their Item Style Classification Numbers from the SDD 1. The consumer chooses the Item Style they would like to use for creating a Total Look, and a clothing Design Preference. The DCAPP 8 sends the Item Style Classification Numbers it has isolated from the SDD 1 to the Central Item Classification Database 1d and it uses the same process of isolating relevant inventory, based on the expert rules 2002, starting with Item Field, Item Style and Design Preference and including such categories as Colour, Style Preference and Generation drawn off the consumer's personal style profile. The DCAPP 8 now displays the inventory with a photograph of what the consumer has chosen and the DCAPP 8 has matched to their personal style profile.

The ‘Create Your Own Total Look’ process (within the DCAPP 8) matches certain Item Types with other Item Types including a preference process: e.g., if Trouser was chosen the 1st choice would be shirt, 2nd choice T-shirt, 3rd choice Shoes etc. In the Create Your Own Total Look, the consumer can exit all choices and progress to purchasing. The consumer chooses one or more Item Types, and the DCAPP 8 uses its 1st preference Item Type to search the SDD 1 for items that match the chosen item/s. The DCAPP 8 uses the chosen Item Field and Item Type to access the SDD 1, isolating the Item Types and the clothing and textile features that match the consumer's Style Profile. The Item Style Classification Numbers from the DCAPP 8 are sent to the Central Item Classification Database 1d where they are matched to any of the same Item Style Classification Numbers held in stock. The matching Item Styles are then be further reduced by matching Design Preference, Colour, Style Preference, Generation etc drawn off the consumer's Style Profile, producing a series of Items Styles by photograph, that match the items that the consumer chose in the previous step. The consumer chooses which items they would like to use in the creation of their Total Look and the chosen items together with the first chosen item are displayed next to the series of Item Styles that the DCAPP 8 has isolated from the next Item Type preference choice, within the Stock Inventory Database. The process of adding Item Types to the Total Look may include every different one, such as Trousers, Shirts, T-Shirts, Jackets, Belts, Shoes, Socks, Jewellery etc, depending on how extensive the consumer wants to be in creating their Total Look, this can include further steps. Many outfits and total can be achieved, once the member has decided what Item Styles they would like to purchase. Through the Web-Based system, they follow the standard on-line procedures, or they follow the procedures of the Instore application. Once the consumer has made their final choices they purchase on-line or print out their final chosen Item Styles in preparation to try on and purchase.

Lifestyle Options

If the member chose one of the Lifestyle Field parameters in step 3550, they are directed to isolate the type of clothing that is matched to the Lifestyle values. A world map is displayed by the DCAPP 8 to select the location and time of year of the Lifestyle activity pinpointed. The world map would be programmed by geographical areas within each country and includes four seasonal times of year, each area and time of year being allocated 1 or more of 5 particular Item Weight codes, as shown in questionnaire 412 number 6.

Once the consumer has chosen the area within the country and the time of year their activity takes place in, the DCAPP 8 uses their Item Weight code together with the Lifestyle Field they chose, to display all Lifestyle activities, and the consumer chooses one and a list of Item Types that are used for that activity are displayed. The list of the DCAPP 8 Item Types displayed that have been matched to a Lifestyle activity have also been matched to a Design Preference (e.g., number 4 of the questionnaire 412 in FIG. 28), and allocated one or more of the Design Preference numbers, based on the expert rules 2002.

Once the consumer has chosen an Item Type, the DCAPP 8 draw all Item Style Classification Numbers that match the consumer's personal style profile and that include the chosen Item Type in them, from the SDD 1 and holds them while it accesses the Central Item Classification Database 1d. The DCAPP 8 uses the chosen Item Type and Design Preference to isolate relevant stock the consumer is searching for from the Central Item Classification Database 1d and uses such categories as Sizing, Colour, Style Preference and Generation drawn off the consumer's personal style profile to finalize the relevant stock choices. It then cross matches the Item Styles from the Central Item Classification Database 1d using the Item Style Classification Numbers with the Item Style Classification Numbers being held from the SDD 1 by the DCAPP 8.

The DCAPP 8 now displays the isolated inventory that it has drawn from the retailer's Inventory Database by photograph, vendor style number and Item Style Classification Number. The consumer is able to click on the photograph of each garment to retrieve information such as: item composition, country of origin, how many are in stock, etc. Once the member has chosen what styles they would like to buy, the add on program presents them with an opportunity to view a number of matching options from the chosen Lifestyle Field and the Create Your Own Total Look process. Once the member has decided what Item Styles they would like to purchase, they follow the standard on-line procedures for the Web-Based application, or for the Instore application. There may be a number of marketing, research or sales questions the individual retailer would like to ask before the member purchases the Item Styles, such as: (i) Would the member like to view new stock coming in?, and (ii) Would the member like to answer a questionnaire?

The DCAPP 8 provides an icon (e.g., displayed on a user interface) that provides a link directly to the Central Item Classification Database 1d and the SDD 1 in case the member would like to widen their search by parameters such as Colour, Style Preference, Generation, Face Shape or Body Line. The DCAPP 8 also has a direct link (e.g., displayed on a user interface) to the CLASS Information Site 10 so the member can select to view their purchase history or receive help or information from the CLASS system 1000. The member could view their another person's purchase history including photos of what had been purchased before if the other person had initially agreed to it and the USB Key or system had been pre-programmed. There is also a note on whatever screens are related to colour informing the customer that all garments have been categorized into 120 colour categories and they can check the photograph carefully to confirm their satisfaction with the colour of the garment.

A CLASS member who is not on the Retailer's Customer Database is asked if they would like to download their personal style profile on all screens they use. There may be incentives to do so. A CLASS member who was not on the Retailer's Customer Database automatically have their personal style profile downloaded at the point of purchase either online or in store. There may be the option of having a secondary set option for the customer, although the add on system and Create Your Own Total Look will probably be enough (refer to SDD 1 matching options).

Life Style Information Directory (LSID) 9

The Life Style Information Directory 9 is a directory that provides information and direction for members or guests on Personal Care, Clothing and Style and Lifestyle Dressing. There are approximately 25 modules within the Life Style Information Directory 9 that a retailer has the option of purchasing to compliment the CLASS system 1000, a number of these modules are necessary for the system to be most effective. A member or non-member may access LSID 9 either on-line or instore once they have entered the system through the DCAPP 8 and then progressed through to LSID. There are modules such as Beauty, Personal Care and Hygiene, Career Dressing the latest fashion trends or Style Tips. The consumer can also move to the CLASS Information Site 10 from LSID for information on CLASS or for help.

If the consumer (member or non-member) chose to open a module within the LSID this action and details of any information the individual requested, answered or received is recorded and transferred by the Administration Program 5 to the Customer Database and added to their file for marketing purposes. A number of the modules are interactive having the ability to work together with the member's personal style profile and a stores inventory. Modules such as Career and Leisure Dressing, that provide a complete list of clothing that is appropriate for particular careers and leisure activities or modules that allow the consumer to create their own clothing wardrobe. The LSID uses the SDD 1 to draw appropriate information out for the use in some of the modules such as Career Dressing. A number of modules from within the Life Style Information Directory 9 are continuously up-graded from the CLASS system head office, modules such as International Fashion Trends, Local Fashion Trends, Fashion News, Celebrity Fashion Trends, Colour, Style and Fabric Forecasting. Example Life Style Information Directory Modules are described in Appendix B.

CLASS Information Site (CIS) 10

The CLASS Information Site 10 is a site that has a number of sections that provide help and marketing information on the CLASS system 1000 and retailer, plus consumer research information for the retailer and CLASS system head office. Details of any information a member requested, answered or received are recorded and transferred by the Administration Program 5 to the Customer Database and added to their file for marketing purposes.

This information site is accessible to all consumers both members and non-members. Information such as how to become a member, how the system works, CLASS and retail policies and the benefits of becoming a member are available together with impressive examples of programs and processes the system uses. The site also provides information on how to update the member's personal style profile and help on how to use the system. The CLASS Head Office Service Centre 18 has a direct link to the CLASS Information Site, allowing regular system and styling information to be upgraded and giving CLASS Head Office direct contact with the consumer. CIS 10 has a direct link from every screen of the DCAPP 8, available through an icon on the screen; the link provides the member with access to help and information services. CIS 10 also has a direct link to the Life Style Information Directory 9, for all consumers to access Personal Care, Clothing and Style and Lifestyle services, interactive programs and information at any time they require when viewing the CLASS Information Site 10, or direct from DCAPP 8. The, Create Or Update Your Own personal style profile 15 is also directly linked to CIS allowing a consumer to try the system in a limited capacity after reading about it in CIS or for a member to update their personal style profile after reading how to do it in CIS. Any companies who use the CLASS system 1000 is able to tailor make their own CLASS Information Site around the standard system foundations and information requirements. The CLASS Information Site 10 includes a consumer feedback option, giving the member or non-member the opportunity to complete a questionnaire or detail any questions, concerns or feedback they may have for the retailer or the CLASS system head office.

P.O.S. Program 11

The P.O.S. Program 11 is the program that processes the sale of any consumer purchases, either in a retail environment or through an online purchase. It can be used in conjunction with an existing retail P.O.S. system, through an interface designed by the CLASS system programmers or can be used as a stand alone system. The P.O.S Program is typically a combination of the CLASS system software and the standard P.O.S. requirements of the particular retailer. The Administration Program 5 has complete access to all transactions made through the P.O.S. Program, enabling it to use the information for accounting and marketing purposes. In a retail shopping environment the CLASS P.O.S. Program 11 processes any product that has a CLASS system Item Classification Number included within the barcode as done with other product coding in stores. The sale is recorded and automatically reduces the inventory from within the relevant Inventory Database. If the member had provided their personal style profile at the point of purchase the sale is added to the members purchase history within the Retailer's Customer Database 3. If the member scans their personal style profile card 14 at the point of purchase or connects their USB Key to the P.O.S. system, the sale can be added to the members card or key and the Retailer's Customer Database 3. The P.O.S. Program 11 when used during an online sale is reached through entering the DCAPP 8 first and then once the Item Style has been chosen the P.O.S. system is used. The P.O.S. Program 11 works in conjunction with the existing online retail P.O.S. system or the CLASS P.O.S. Program could completely replace the existing P.O.S. system. The online P.O.S. Program automatically deducts sales from inventory and perform all other standard P.O.S. requirements. It updates the purchase history of the member in the Retailer's Customer Database 3, the Member's Personal Hard Drive 13 and the member's USB Key if the member was using the USB key to enter their details from their personal Hard Drive.

USB Key Program 12

The member has an analysis done either at a retail store, at an independent Styling Studio or by a mobile stylist on location, 2. The member is provided with a USB Key that contains their personal style profile and personal information. Once a consumer becomes a member they download their personal style profile from the USB Key onto their personal hard drive 13 as back-up in case they lose the USB Key. If the personal style profile Analysis 2 is carried out at a retailer, the retailer automatically transfers the member's personal style profile to their Retailer's Customer Database 3 through entering the Instore Computer Terminal 16 and using the DCAPP 8 to download it. This could be used as back-up for the member. A member can transfer their personal style profile to any Retailer's Customer Database 3 using their USB Key through the DCAPP at any time they like after a personal style profile analysis has been carried out. A retailer cannot download a personal style profile onto their Retailer's Customer Database 3 from a USB Key if the member was only browsing and did not purchase something. If the member did purchase something during an on-line transaction and their personal style profile was not on the Retailer's Customer Database 3, the member's personal style profile is automatically downloaded from the USB Key. During an Instore transaction, the personal style profile is downloaded from the P.O.S. Program 11 onto the Retailer's Customer Database 3 if the member allows their USB Key to be connected to the system at the point of purchase. The USB Key has global use and allows the member to use their personal style profile to access any retail shop or web-based retailer that uses the CLASS software system through the Daily Access & Purchasing Program 8. When sales are made and added to the USB Key purchase history they are automatically downloaded to the member's Hard Drive next time the USB Key is connected. However the new purchases are not be automatically downloaded to a different Retailer's Customer Database purchase history the next time they buy something from that different retailer. The total purchase history from multiple stores remains on the USB Key and Hard Drive only, unless the member decides to download it somewhere else. The alternative is for the member to connect the USB Key to the computer they are using: the Consumer's Computer 13 accesses a retailer's website 17 that uses the CLASS system 1000, enters the DCAPP 8 locates what they want to buy through the DCAPP 8 and then continues to purchase it through the DCAPP 8 and the on-line P.O.S. Program 11. The member can upgrade basic personal style profile details such as address, career etc only through using a USB Key to connect to the system either online, retailer's website 17 or at an Instore Computer Terminal 16. The upgrade is done through using the DCAPP 8 to access the Create Or Update Your Own personal style profile and once completed automatically upgrades the USB Key, the Consumer's Computer 13 when using the DCAPP 8 online and the Retailer's Customer Database 3 when upgrading on an Instore Computer Terminal 16. When personal details need upgrading such as proportions and measurements a stylist is required, they uses the members USB Key in conjunction with their computer to make the changes to the personal style profile and the USB Key. The USB Key is used in upgrades so it ensures the profile changes can be transferred to the Consumer's Computer 13 at a later time, if the upgrading was done at a instore or external location. When the USB Key is used after it has been upgraded, it automatically upgrades the Retailer's Customer Database 3 on a Web-based or Instore application. The CLASS system 1000 and the USB Key Program 12 provide the opportunity for a member to hold multiple Style Profiles and member information on a USB Key, known as Secondary Style Profiles, giving the member the ability to shop for family and friends knowing their sizes, colours etc and possibly purchase history. The program on the USB Key allows the member to transfer their personal style profile to a personal Hard Drive 13 and in turn have a personal style profile of a friend or family member transferred off the Hard Drive onto their USB Key. The USB Key Program 12 requires authentication to transfer member Style Profiles, each member has a Pin number and before the personal style profile is transferred from a Hard Drive the Pin number is required. Once a personal style profile is on a USB Key the details can be viewed by the holder of the USB Key, including purchase history and other personal details.

The USB key may refer to any reliable portable computer-readable medium, such as a magnetic disc, optical disc, memory card, memory in a portable device (e.g., a PDA or telephone), etc.

Consumer's Computer 13

The Consumer's Computer 13 is used to back up the USB Key and used to shop online, directly accessing the retailer's website 17 and then entering the CLASS system 1000 through the DCAPP 8 and using the online personal style profile. The consumer may isolate clothing from within a retailer's inventory, print out a copy of it including where in the store it is and then go to the store find the item or give the print out to a store assistant to find. The Consumer's Computer 13 can also hold personal style profiles of friends and family that the member can use when shopping online. The Consumer's Computer 13 is also used to transfer family and friends Style Profiles from their USB key onto the member's USB Key. The Consumer's Computer 13 has a temporary link to the Independent Styling Studio or Stylist 19, in case personal style profile upgrades are required by the member, marketing purposes and system and styling information. The CLASS Head Office Service Centre 18 has a temporary link to the Consumer's Computer 13 due to the Independent Styling Studio 19, sending the head office members information. Any member or consumer can enter the CLASS Web Site for information on the system and its services.

The consumer's computer 13 can be a personal computer with a standard processor, operating system and application software, such as a Lenovo desktop computer with Microsoft Windows and a Firefox Browser, or an Apple laptop computer with Apple OSX and a Safari Browser. The consumer's computer 13 can also be a portable computing device with an Internet connection, such as an Internet-enabled telephone (e.g., an Apple iPhone or Nokia smart phone) or a wireless personal digital assistant or palm-top computer.

Member's Personal Style Profile Card (MSPC) 14

The member's personal style profile card 14 is a card that contains the personal style profile of the member and is issued after a personal style profile Analysis has been done 2. It is posted to the member once if it has been produced by a card company. The card operates much like a USB key carrying the personal style profile of the member created at the point of the personal style profile Analysis 2. The card can carry third party personal style profile if desired. The member's personal style profile card 14 can only be used in an instore retail application. It is swiped at an Instore Computer Terminal 16 allowing access to the DCAPP 8 and would also be swiped through the P.O.S. Program 11 at the point of purchase to allow the sale to be recorded onto the card for purchase history and marketing purposes. If a member would like to transfer another personal style profile onto their card it can only be done from an Instore Computer Terminal 16 through the DCAPP 8.

The personal style profile card 14 may refer to any reliable portable computer-readable medium, such as a magnetic disc, optical disc, memory card, memory in a portable device (e.g., a PDA or telephone), etc.

Create Or Update Your Own Personal Style Profile (COUYOSP) program 15

The COUYOSP Program 15 has been created to allow consumers who are not members to try in a limited capacity the CLASS system 1000 of matching retail clothing and related product to their personal characteristics and for existing members to update a limited number of personal fields in their Style Profile. The program includes a set of multiple choice questions such as:
1. What colour are your eyes?
2. What complexion would you consider yourself?
3. What colour is your hair?
4. What face shape do you consider you have?
5. What is your style preference?
6. What is your size in various clothing items?
7. What is your height?

Answers to these questions give the system enough information to produce a limited amount of matching capabilities due to the limited amount of categories applied to the consumer. The consumer is providing the results and unfortunately that means there are inaccuracies: the system also acknowledge this and a professional style analysis are recommended to ascertain the correct colour and style results. The DIY personal style profile that the consumer has created is saved for one day. The consumer is encouraged to have a professional personal style profile analysis done because the consumer needs to do a new DIY profile every time they want to use the system unless they use it in the same day. The name, details and date of the created personal style profile is stored in COUYOSP 15 for marketing purposes. If the consumer would like to create their own personal style profile, or a member would like to update their personal style profile, they must enter the DCAPP 8 through either the retailer's website 17 or the Instore Computer Terminal 16. Once in the DCAPP 8, the consumer proceeds to COUYOSP 15 and follow the necessary prompts to complete their desired action. Once the consumer has created a personal style profile, the DCAPP 8 uses the personal style profile to recommend one or more items. Photos of the Items are displayed and the consumer then has a choice of what to purchase. The P.O.S. program is used both on the Retail and Web-based application as it is when a member is using the system. If a member wanted to update their Style Profile, they are able to update a number of their personal fields, including name, address, career, leisure activity and size (which are the most frequent). The personal proportions and measurements of the member's personal style profile can only be changed by a qualified stylist. The Administration Program 5 downloads any information the consumer left, sending updated member Style Profiles to the Retailer's Customer Database 3 and using newly created personal style profile Information for marketing purposes.

Instore Computer Terminal (IST) 16

The Instore Computer Terminal is the point where members and non-members access the CLASS system 1000 and services offered such as: checking on stock, browsing the system for bargains that match their Style Profile, buying for family or friends, changing their Style Profile, completing a DIY personal style profile or checking out the latest fashion trends in the Life Style Information Directory. The instore computer terminal is situated in a special area of the store, e.g., a newly formed styling and service area that should have some visibility to the passing foot traffic. The member enters the Instore Computer Terminal using their USB Key, their member's personal style profile card 14, their online personal style profile, or directly entered personal details. The personal style profile is retrieved from the Retailer's Customer Database 3, and the member is directed through to the DCAPP 8 where they access what service they require. Once finished with the DCAPP 8, they may require a print-out of where in the store the garments they want to buy are, or they may require a print out of information they sourced while browsing the CLASS system 1000. The non-member enter the Instore Computer Terminal as a guest, entering the DCAPP 8 and then moving through with limited access to the system once they have finished they are able to receive a print out of whatever services they were able to access including the DIY Style Profile.

Retailer's Website 17

The retailer's website 17 is where a high street retailer or a specialist on-line retailer uses the CLASS system 1000 to sell and offer services. It is the entry point for the consumer into specialist CLASS system 1000 services that an individual retailer has configured to suit their business requirements. To enter the retailer's website and access the CLASS services, the consumer uses their USB Key connected to their hard drive, or their personal style profile on their hard drive. If the member does not have their personal style profile available they are able to open the retailer's website 17 and put their personal details into the DCAPP 8, retrieve their personal style profile from the Retailer's Customer Database 3 (i.e., the online personal style profile), which can be limited to if they have used the retailer before and their details are stored. Once the analysis has been complete, the stylist emails the personal style profile from the Independent Styling Studio 19. The personal style profile and personal information are sent to the retailer's website 17, then directed straight to the Retailer's Customer Database 3. When a member opens the retailer's website and enters their personal style profile, the Daily Access and Purchasing Program 8 is activated and provide what service the member requires. If the Member would like to print out any information from the CLASS system 1000 they are able to from their own printer. If they would like to purchase something, the DCAPP 8 directs them to the retailer's on-line P.O.S. Program 11. A non-member enters the retailer's website and has the option of opening the CLASS system 1000 to access the services offered; once they do this they enter the DCAPP 8, where they are then be given the choice of services offered. Once the non-member has finished their browsing they can print out any information they have access to, or if they would like to purchase something the DCAPP 8 directs them to the retailer's on-line P.O.S. Program 11. The retailer's website 17 is where the retailer launches their online customer target marketing, using the Administration Program 5 and customer and inventory information, fro the Customer Database 1g,1k and the Inventory Database 1h,1l to action the type of marketing the retailer requires and the Retailer's Customer Database 3 for the targeted customers. If a retail buyer completes an inventory order away from the office, using the Inventory Order Classification Program 4, which requires immediate processing, the order is emailed to the Administration Program 5 using the retailer's website 17 as the entry point into the retailer's system.

CLASS Head Office and Service Centre (CHOSC) 18

This is the link between the CLASS Head Office their customers and the consumer. The CLASS Head Office is a company with a number of different departments. There are the Software Service and Programming, Customer Sales and Service, Styling Analysis and Development, CLASS Licensing, Studio and System Production, Fashion Research and Development, New Product Development, Consumer Database and Development and CLASS Marketing. CHOSC 8 is linked to each retailer's CLASS system 1000, as any current software supplier links to their customer's software, shown in both the Web-Based and Instore Application from the Administration Program 5 to CLASS Head Office Service Centre 18. This link is for regular software upgrades, new fashion or different product modules, marketing support, trend and textile updates, new and improved Lifestyle services for the SDD 1 and the Life Style Information Directory.

Independent Styling Studio or Stylist 19

The Independent Styling Studio 19 uses the personal style profile analysis program 2 to carry out a consumer analysis and present the required personal style profile and information to the online personal style profile or the USB Key, for the consumer to use in any retail CLASS system 1000. The Independent Styling Studio 19 can also order a personal style profile card 14 off the personal style profile analysis program 2 when they become available. The stylist may be contracted by a retailer or online retailer to analysis their customers, once this has been done the Independent Styling Studio 19 sends the personal style profile to the Central Consumer Style Profile Database 1e (e.g., via the retailer's website 17). This is done through a permanent link from the Styling Studio or a temporary or wireless link sent from a laptop. The Independent Styling Studio 19 also sends the CLASS Head Office Service Centre 18 the Style Profiles of the new CLASS members. CLASS can offer the consumers system information, information on CLASS retailers and stylist information.

A link between the Independent Styling Studio 19 and the Consumer's Computer 13 is used for updating the members personal style profile if necessary and to supply the members with system and fashion information.

Interpretation

Many modifications will be apparent to those skilled in the art without departing from the scope of the present invention as herein described with reference to the accompanying drawings.

APPENDIX A: Example questions used in the Personal Style Profile Analysis Program

Level 2: Physical Analysis Classification examples

Sex:
Male/Female

Generation:
Four categories—12-21, 22-35, 36-55, 56+

Women's Personal Colour Analysis;
The seasonal colour analysis has a scientific grounding using four seasons—Winter: Spring: Summer: Autumn: There are 120 colours, therefore each customer is analysed and allocated approximately 30 colours for their colour palette. It gives results with certainty, such as which colours make the client physically look their best and which ones to avoid, assessing and recommending
Depth—Light< >Colour
Clarity—Bright< >Muted
Undertone—Cool< >Warm
Colour of eyes, colour of hair.
The colour recommendations apply to clothing and make up and the colours recommended are used during the immediate consultation. In a department store environment a preferred brand may be chosen for this make-up colour analysis.

Men's Personal Colour Analysis;
As women's colour analysis.

Women's Personal Style Preference;
One of 5 style categories is allocated—Classic, Sporty, Natural, Dramatic, Romantic—reflecting the look they are most comfortable with and their taste, lifestyle and personality. There is usually a combination of both with a dominant preference.

Men's Personal Style Preference;
As women's style preference except there is no Romantic
Women's Personal Proportions and Measurements;
This module analysis the clients proportions with the relative lengths and widths of parts of the body using approximately 5 categories—this is necessary to select the clothes that give the right optical illusion and re-balance the proportions by using the correct lengths and lines of garments—it is physically done using a ribbon and stick test. The personal measurements are taken to give the size details to match clothing. It is very important to be comprehensive due to the various differences in body shape, especially for women. The measurements may also be used for ‘made to measure’ clothing—primarily for business women.

Men's Personal Proportions and measurements;
As Women's Personal Proportions.

Women's Personal Body Lines;
Body lines determine the correct fabric, cut and finishes of garments—with the principle to reflect the natural lines of the body—assessed in two halves—above and below the waist. There are four groups Curved/curved, Straight/straight, Straight/curved, Curved/straight. This determines how the right details and finishes help to define, balance and emphasise her total look. Recommending such details as stiff, structured, crisp fabrics and square or v-necklines for straight line details and rounded lapels, shawls, soft gathered pleats and rounded buttons and soft flowing fabrics for curved details.

Men's Personal Body Lines;
Similar to Women's Personal Body Lines.

Women's Client Face Shape;
The shape of the face maybe analysed—oval, oblong, round, pear, heart, square, triangle. This will determine the most flattering shapes to be worn around the face—reflecting the overall impact of the face shape & features, determining the shape of glasses/jewellery/neckline/hairstyles etc.

Men's Client Face Shape;
As women's Client Face Shape.

Once the results of the proportions and body lines have been complete and it is established that the individual has large breasts or a long neck etc questions must be asked as to whether the individual would like to highlight or hide those personal proportions because different people feel differently about their body. Some want loose clothing, some want tight clothing (highlighting or hiding large breasts)—is this down to the individual choosing the size of garment. A similar thing will happen with colour—will the individual wear black—some yes some no.

Level 3: Life Style sample questions (Lifestyle Profile)

Career:
a) What is your Profession? Each profession is designated with appropriate clothing.
b) Are you required to wear particular clothing?
c) Is the clothing purchased from specialist clothing companies? ie protective clothing, uniforms.
d) What type of clothes do you wear to work?
e) Is there a particular colour that you need to wear for work?

Leisure Time:
f) What do you do for your leisure time? Each leisure activity is designated with appropriate clothing.
g) Do you eat out, entertain at home, hobbies, play sport, watch sport, bush walk.
h) How much time do you spend on each activity? The idea is to work out how much time is spent in each area. This will determine how much of a particular type of clothing is required, ie how many trousers, dresses, jeans etc and if the shirts should be sporting, button down, peak collar, casual, business, fashion, etc.

Home Time:
i) What do you feel comfortable wearing at home?
j) What activities do you do at home? Gardening, renovation, passive exercise, relaxing etc?
k) Is there are a range of particular clothes options that are worn at home, including tracksuits, pyjamas, leisure suits, shorts?

Appendix B: Life Style Information Directory Modules

Personal Care.

1.) Make-Up Application and equipment; instructions on how to apply make-up correctly, equipment to use, hygiene rules, selecting colour and brands, taking care of make-up and the equipment. This module has general make-up colour information but can also be tailored to include the specific brand colours that a retailer or stylist uses. In a department store environment all make-up brands and their colour palettes could be included

2.) Personal Proportion and Body Line Dressing;

3.) Beauty, Personal Care and Hygiene; this module is large and beauty will probably be split into its own module. Personal skin care and hygiene are very important and are often taken for granted.

4.) Personal Health; this optional module may give easy to understand personal health information including diet, exercise and healthy living hints.

Clothing and Style

5.) The Psychology of Colour; is a module that includes the effect colour has on moods and emotions, which colours have positive and negative effects. What psychological colours are authoritative and appropriate for interviews or for one to look more approachable etc.

6.) Colour Co-ordination; this is an optional module that takes into consideration the client's colour analysis and gives them hints on how to co-ordinate the colours that they uses in their wardrobe. This colour module includes colour information such as lighter colours reflect light and therefore make things appear lighter and darker colours absorb light making things look smaller and the optical illusions with proportion and line that certain colours create

7.) Wardrobe Management; an optional module that gives a printout of how an individual should manage their wardrobe in three steps. This module is useful for the stylist who will do the consultancy, and for department stores and any retailer who will need to continue to train new staff.

8.) Style Tips; another optional module that may give objective style advice in all areas for both men and women. It includes the five styling categories and general tips that the system uses, allowing non members to see how the personal style profile is designed. This module is used as an information source by retail staff but may be purchased as extra information by the client.

9.) Hairstyle Information; this hairstyle index includes an index with all types of hairstyles, it links with face shape and colour and give automatic recommendations. The information to programme this module is readily available from books and over the Internet. There are also be seasonal hairstyles—what's in and what's not. What type of hairstyle the celebrities are wearing.

10.) Shoe Style and Information

11.) Proper Fit and Proportion Dressing; advice on fitting the right size, alerting garments, and standard sizing. Information on the proportions of men and women, including information such as disguising a full breast, enhancing a small breast, disguising a pear shaped figure, disguising a full tummy.

12.) Clothing Care; tailoring shirts, suits shoes and tops, how to wash certain fabrics, what to launder etc. Optional module purchase by the end user or retailer.

13.) Dressing Information; how to use accessories and colour, dressing for certain occasions, smart, casual, sport, evening, fashion. It will also include an index of facial features—major features include straight/curvy lines—softer features (rounded cheeks/small nose etc) angular features (square/angular chin, thin lips etc).

14.) Accessory and Jewellery Information; all styles of accessories including shoes, jewellery, bags, belts etc are included in this index.

15.) Maternity Information; what to wear, the comfort factor, suitable colours and accessories. Another optional module purchase.

16.) Age Dressing, Colour and Style Protocols; an optional dress, style, and colour module that gives information on changing dress codes with age, fading skin colours and pigmentation, style and images for aging men and women.

17.) International Clothing Codes and Business Protocols; an optional module designed for the international business man or woman who need to know how to dress and act when dealing with different cultures across the world. It provides vital information on dress codes around the world, what customs allow what type of clothing, what type of clothing is appropriate for business, leisure and holiday time etc.

18.) International Seasonal Clothing and Weather Mapping; this module includes the mapping of world weather and what clothing is appropriate for what season of the year and for where the individual lives, it gives seasonal clothing options. There are five weather groups, Heavy Winter, Winter, Tran seasonal, Summer and High Summer, all items are classified into these groups.

19.) Business Clothing Co-ordination and Professional Protocols; this module gives advice to business men and women on what should and should not be worn in certain industries, what to wear at certain levels of management, implications of particular colours and co-ordination that is appropriate, plus how to put together and co-ordinate particular looks. Tips for success at work including business ethics and the psychological importance of looking good.

Lifestyle

20.) Career Dressing; this module categorizes every type of job and has detailed information on what clothing supports what job, and when linked to the colour, styling and clothing modules are able to give the client the perfect collection of clothing recommendations.

21.) Leisure Time Categories; this module categorizes every type of personal leisure or hobby activity into a group and index what clothing is appropriate for each leisure activity allocated. This index also links to the colour, styling, accessories and other modules and can produce a print out and recommendation for the right clothing and accessories in the correct colours. A world map is displayed first then the time of year—same with holiday

22.) Home Time Dressing; this module is an optional index and will categorize the many different home activities—indoor and outdoor and what clothing is the most comfortable and appropriate, linking to the modules that are necessary to take information from.

23.) Holiday Time Dressing; will provide what clothing is appropriate for what holiday.

24.) Sports Dressing

1. An item recommendation process, executed by a computer system, including:
receiving item data representing item features of at least one item;
receiving personal data representing personal features, and associated with a personal style profile, of at least one person from a user;
accessing and processing rules data representing links between item features and personal features of style profiles;
receiving inventory data representing available items in a retailer inventory of a retailer to the person; and
generating recommendation data representing an item recommendation of the item, selected based on the available items, the item features, the style profile and at least one link between them.

2. An item recommendation process, executed by a computer system, including:
receiving item data representing item features of at least one item;
receiving personal data representing personal features, and associated with a personal style profile, of at least one person from a user, wherein the personal features relate to lifestyle activities;
accessing and processing rules data representing links between item features and personal features of style profiles; and
generating recommendation data representing an item recommendation of the item, selected based on the item features, the style profile and at least one link between them, wherein the link is between the lifestyle activities and the item features.

3. An item recommendation process, executed by a computer system, including:
receiving item data representing item features of at least one item;
receiving personal data representing personal features, and associated with a personal style profile, of at least one person from a user;
accessing and processing rules data representing links between item features and personal features of style profiles;
generating recommendation data representing an item recommendation of the item, selected based on the item features, the style profile and at least one link between them; and
generating further recommendation data representing a further item recommendation of a further one item, selected based on the item features, the personal features, the link between them and the recommended item.

4. An item recommendation process as claimed in claim 1, further including receiving user selection data representing personal features and item features selected by the user, and selecting the item recommendation based on the user selection data.

5. An item recommendation process as claimed in claim 4, wherein the user selection data includes price data representing a price range, and the item recommendation process further includes accessing retailer data representing a price of the item, and selecting the item recommendation based on the price and the price range.

6. An item recommendation process as claimed in claim 1, wherein the recommendation data includes a secondary item recommendation of the item, generated based on a secondary link in the rules data between the personal features and at least one secondary item feature of the item.

7. An item recommendation process as claimed in claim 1, further including receiving item selection data representing an item selection by the user of the item recommendation.

8. An item recommendation process as claimed in claim 1, further including generating directions data representing directions for the user to access the recommended item.

9. An item recommendation process as claimed in claim 8, further including printing the directions data to display a map to locate the recommended item.

10. An item recommendation process as claimed in claim 8, further including processing the directions data to display a website of an online retailer with the recommended item.

11. An item recommendation process as claimed in claim 1, further including receiving order data representing an order for the recommended item, and storing the order data in association with the personal style profile.

12. An item recommendation process as claimed in claim 11, further including receiving further inventory data representing further available items including the ordered item in the retailer inventory, and generating availability data indicating availability of the ordered item for the user.

13. An item recommendation process as claimed in claim 1, further including receiving purchase data representing a purchase of the recommended item, and storing the purchase data in association with the personal style profile.

14. An item recommendation process as claimed in claim 13, further including sending the personal data and/or the purchase data for generating a marketing-communications message.

15. An item recommendation process as claimed in claim 13, further including displaying a purchase history of the person based on the stored purchase data.

16. An item recommendation process as claimed in claim 1, further including generating the item data based on input data from a retailer, a supplier or a manufacturer of the item, and based on a set of selectable item values for the item features.

17. An item recommendation process as claimed in claim 16, further including storing the item data in a network accessible database.

18. An item recommendation process as claimed in claim 1, further including generating the personal data based on input data from the person, and based on a set of selectable personal values for the personal features.

19. An item recommendation process as claimed in claim 18, further including generating additional personal data for the personal style profile based on additional input data from the person.

20. An item recommendation process as claimed in claim 1, further including generating the rules data based on input data from a stylist based on a set of selectable item values for the item features, and based on a set of selectable personal values for the personal features.

21. An item recommendation process as claimed in claim 1, wherein the personal data represents a plurality of personal style profiles of a corresponding plurality of persons.

22. An item recommendation process as claimed in claim 1, further including storing the personal data representing the personal style profile in a network accessible database.

23. An item recommendation process as claimed in claim 1, further including storing the personal data representing the personal style profile in a portable storage device.

24. An item recommendation process as claimed in claim 23, wherein the portable storage device is associated with a USB key, a memory card, a mobile telephone, a cellular telephone or a personal digital assistant.

25. An item recommendation process as claim 1, further including sending a selection of the item data to a retailer database corresponding to items being delivered to the retailer.

26. An item recommendation process as claimed in claim 1, wherein the item data is an item record in a database.

27. An item recommendation process as claimed in claim 26, wherein the item record includes a reference number or code representing a unique set of item features.

28. An item recommendation process as claimed in claim 26, wherein the item record includes one or more item parameters, each having one or more possible item values.

29. An item recommendation process as claimed in claim 1, wherein the item data represents a plurality of items having substantially similar features associated with the item parameters.

30. An item recommendation process as claimed in claim 1, wherein the personal data is a personal record in a database.

31. An item recommendation process as claimed in claim 30, wherein the personal record includes one or more personal parameters, each having one or more possible personal values.

32. An item recommendation process as claimed in claim 1, wherein the personal style profile represents a person's locality, colour profile, face shape profile, personal body line profile, personal proportions profile, style preference profile, and/or preferred appearance profile; and
wherein the item data represents the item's sex, item field, item type, structural features, item composition, design features, design trimmings, fabric, finish and/or pattern/print.

33. An item recommendation process as claimed in claim 1, further including sending the recommendation data to the user.

34. A computer-readable storage medium having stored thereon program instructions for executing the steps of an item recommendation process as claimed in claim 1.

35. An item recommendation system including a secure central online database, in communication with a plurality of communications systems of retailers, for performing the steps of an item recommendation process as claimed in claim 1.

36. An item recommendation system including a recommendation engine configured to:
receive item data representing item features of at least one item from a categorised items database;
receive personal data representing personal features in a personal style profile of at least one person from a user;
access rules data representing at least one link between the item features and the personal features, corresponding to the item in an expert rules database;
receive inventory data in an inventory database representing available items in a retailer inventory of a retailer to the person; and
generate recommendation data representing an item recommendation of the item, selected based on the available items, the item features, the personal features and the link between them.

37. An item recommendation system including a recommendation engine configured to:
receive item data representing item features of at least one item from a categorised items database;
receive personal data representing personal features in a personal style profile of at least one person from a user, wherein the personal features relate to lifestyle activities represented by life style data in a life style database;
access rules data representing at least one link between the item features and the personal features, corresponding to the item in an expert rules database; and
generate recommendation data representing an item recommendation of the item, selected based on the item features, the personal features and the link between them, wherein the link is between the lifestyle activities and the item features.

38. An item recommendation system including a recommendation engine configured to:
receive item data representing item features of at least one item from a categorised items database;
receive personal data representing personal features in a personal style profile of at least one person from a user;
access rules data representing at least one link between the item features and the personal features, corresponding to the item in an expert rules database;
generate recommendation data representing an item recommendation of the item, selected based on the item features, the personal features and the link between them; and
generate further recommendation data representing a further item recommendation of a further one item, selected based on the item features, the personal features, the link between them and the recommended item.

39. An item recommendation system as claimed in claim 36, further including a user interface configured to receive user selection data representing personal features and item features selected by the user, and selecting the item recommendation based on the user selection data.

40. An item recommendation system as claimed in claim 39, wherein the user selection data includes price data representing a price range, and the item recommendation process further includes accessing retailer data representing a price of the item, and selecting the item recommendation based on the price and the price range.

41. An item recommendation system as claimed in claim 36, wherein the recommendation data includes a secondary item recommendation of the item, generated based on a secondary link in the rules data between the personal features and at least one secondary item feature of the item.

42. An item recommendation system as claimed in claim 36, further including an item input module configured to generate the item data based on input data from a retailer, a supplier or a manufacturer of the item, and based on a set of selectable item values for the item features in an item style directory database.

43. An item recommendation system as claimed in claim 36, further including a network-accessible central item classification database, in communication with the recommendation engine, for storing the item data.

44. An item recommendation system as claimed in claim 36, further including a personal input module configured to generate the personal style profile data based on input data from the person, and based on a set of selectable personal values for the personal features in a style profile directory database.

45. An item recommendation system as claimed in claim 36, further including a network-accessible central style profile database, in communication with the recommendation engine, for storing the personal data.

46. An item recommendation system as claimed in claim 36, further including a rules input module configured to generate the rules data based on input data from a stylist, the input data being based on a set of selectable item values for the item features and a set of selectable personal values for the personal features.

47. An item recommendation system as claimed in claim 36, further including an expert rules database, in communication with the recommendation engine, for storing the rules data.

48. An item recommendation system as claimed in claim 36, further including a retailer database configured to receive item data for a retailer corresponding to items being delivered to the retailer.
